(19) United States
(12) Patent Application Publication
(10) Pub. No.: US 2012/0112595 A1
(43) Pub. Date: May 10, 2012

(54) STATOR AND CAGE COIL

(75) Inventors: Atsushi Watanabe, Toyota-shi (JP); Masayoshi Haga, Nagoya-shi (JP)

(73) Assignee: TOYOTA JIDOSHA KABUSHIKI KAISHA, Toyota-shi (JP)

(21) Appl. No.: 13/142,131

(22) PCT Filed: Nov. 30, 2009
(86) PCT No.: PCT/JP2009/070438

§ 371 Date: Jun. 24, 2011

(30) Foreign Application Priority Data
Dec. 25, 2008 (JP) 2008-330056

(51) Int. Cl. H02K 3/28

(52) U.S. Cl. 310/207

(57) ABSTRACT

A cage coil includes a first combined conductor constituted of six first conductors each being formed in a continuous zig-zag pattern, the first conductors being overlapped sequentially with displacement, and a second combined conductor including six second conductors each being formed in a continuous zig-zag pattern, the second conductors being overlapped sequentially with displacement, and the second combined conductor being placed with displacement of one pitch from the first combined conductor, the first and second combined conductors are overlapped into a conductor assembly, the conductor assembly being wound by five turns. A stator includes the above cage coil.

### TECHNICAL FIELD

The present invention relates to a stator to be used for a motor and others and more particularly to a stator and a cage coil having a wave winding coil made of a conductor (a conductor wire) wound in a wave form.

### BACKGROUND ART

Patent Literature 1 discloses a technique of combining a plurality of wave winding coils each made of a conductor (wire) wound in a wave form so that the coils are displaced or offset from each other by one slot pitch.

If a stepped portion 223 shown in FIG. 3 of Patent Literature 1 is formed in one end of each conductor, which is not obviously described in the specification and drawings, the other end has to be formed with a reversed stepped portion conforming to the stepped portion 223. Otherwise, the coils are sequentially displaced and thus coil end portions could not be made circular.

If the reversed stepped portion is formed in the other end and two wave winding coils are overlapped as described in Patent Literature 1, the two coils could not be combined in simple overlapping position, which is not clearly described in Patent Literature 1, and they necessarily have to be sequentially braided. Patent Literature 4 does not concretely describe the stepped portion.

### CITATION LIST

### Patent Literature

Patent Literature 1: JP2000-069700 A

Patent Literature 2: JP2002-153001 A

Patent Literature 3: JP2008-113539 A

Patent Literature 4 JP2008-253063 A

### SUMMARY OF INVENTION

### Technical Problem

However, the technique disclosed in Patent Literature 1 has the following problems. Specifically, even though it is not described in Patent Literature 1, the present applicants actually found from an experiment that the wave winding coils had to be not only simply overlapped but also braided in sequence. This configuration is apt to decrease production efficiency.

The present invention has been made to solve the above problems and has a purpose to provide a cage coil and a stator with high production efficiency.

### Solution to Problem

(1) To achieve the above object, one aspect of the invention provides a stator comprising: a cage coil including: a conductor assembly constituted of a first combined conductor and a second combined conductor that are overlapped, the conductor assembly being wound by a plurality of turns, the first combined conductor including a plurality of first conductors each being formed in a continuous zig-zag pattern, the first conductors being sequentially overlapped one on another with displacement; and the second combined conductor including a plurality of second conductors each being formed in a continuous zig-zag pattern, the second conductors being sequentially overlapped one on another with displacement, and the second combined conductor being placed with displacement of one pitch from the first combined conductor. Herein, one pitch represents half of one cycle of a conductor (wire) formed in a zig-zag pattern (a meandering pattern), for example, the length from a peak of an upward bent portion to a peak of an adjacent upward bent portion (not a valley).

(2) In the stator set forth in (1), preferably, the first conductors sequentially overlapped with displacement have overlapping portions each including a detour portion for causing a first conductor overlapped behind to detour a preceding first conductor, and the second conductors sequentially overlapped with displacement have overlapping portions each including a detour portion for causing a second conductor overlapped behind to detour a preceding second conductor.

(3) In the stator set forth in (2), preferably, each detour portion of the first and second conductors is formed in a radial direction of the cage coil, and the detour portions of the first conductors have sequentially wider widths and the detour portions of the second conductors have sequentially wider widths.

(4) In the stator set forth in (3), preferably, each overlapping portion of the first conductors sequentially overlapped with displacement includes a stair portion in which the first conductor placed behind overlaps in close contact with the preceding first conductor in an axial direction of the stator.

(5) In the stator set forth in one of (1) to (4), preferably, the overlapping portions of the first combined conductor and the overlapping portions of the second combined conductor are alternately arranged in coil end portions so that each portion of the conductor assembly includes two overlapping conductors.

(6) To achieve the above purpose, another aspect of the invention provides a cage coil comprising: a conductor assembly constituted of a first combined conductor and a second combined conductor that are overlapped, the conductor assembly being wound by a plurality of turns, the first combined conductor including a plurality of first conductors each being formed in a continuous zigzag pattern, the first conductors being sequentially overlapped one on another with displacement; and the second combined conductor including a plurality of second conductors each being formed in a continuous zig-zag pattern, the second conductors being sequentially overlapped one on another with displacement, and the second combined conductor being placed with displacement of one pitch from the first combined conductor.

(7) In the cage coil set forth in (6), preferably, the first conductors sequentially overlapped with displacement have overlapping portions each including a detour portion for causing a first conductor overlapped behind to detour a preceding first conductor, and the second conductors sequentially overlapped with displacement have overlapping portions each including a detour portion for causing a second conductor overlapped behind to detour a preceding second conductor.

(8) In the cage coil set forth in (7), preferably, each detour portion of the first and second conductors is formed in a radial direction of the cage coil, and the detour portions of the first conductors have sequentially wider widths and the detour portions of the second conductors have sequentially wider widths.

(9) In the cage coil set forth in (8), preferably, each overlapping portion of the first conductors sequentially overlapped with displacement includes a stair portion in which the first conductor placed behind overlaps in close contact with the preceding first conductor in an axial direction of the stator.

(10) In the cage coil set forth in one of (6) to (9), preferably, the overlapping portions of the first combined conductor and the overlapping portions of the second combined conductor are alternately arranged in coil end portions so that each portion of the conductor assembly includes two overlapping conductors.

### Advantageous Effects of Invention

The stator and the cage coil having the above configurations can provide the following operations and advantages.

According to the stator and the coil having the above configurations described in (1) and (6), the, first and second conductors are simply overlapped. No braiding is required. Thus, the stator can achieve enhanced production efficiency.

In the case where the conductors are simply overlapped, coils are sequentially displaced. The outer periphery of a cage coil made by winding such coils could not be made circular. On the other hand, in the case where a cage coil is made of three, U, V, and W phase coils for forty-eight slots, for example, the coils are sequentially displaced in the slots and returned at a fixed interval. Accordingly, slight cogging and the like may occur but sufficient motor power can be output.

To avoid the cogging, it is preferable to provide a little margin in a longitudinal direction of a coil end and plastic-deform the coils mounted in the slots by pressing to make the outer periphery circular.

According to the above configurations (2) and (7), furthermore, the first and second conductors are simply overlapped. No braiding is required. Thus, the stator can achieve enhanced production efficiency. Furthermore, the outer periphery of the cage coil can be made circular without pressing in a later process, thereby uniformly mounting each coil in the slots.

According to the above configurations (3) and (8), furthermore, the plurality of first conductors are overlapped by striding over the preceding ones. No braiding is required. Thus, the production efficiency can be enhanced. Furthermore, the outer periphery of the cage coil can be made circular without pressing in a later process, thereby uniformly mounting each coil in the slots.

According to the above configurations (4) and (9), furthermore, the volume of a coil end can be reduced.

According to the above configurations (5) and (10), furthermore, any portion of the conductor assembly including the coil end portions includes two overlapping conductor segments. Thus, the production efficiency can be enhanced. Furthermore, the outer periphery of the cage coil can be made circular without pressing in a later process, thereby uniformly mounting each coil in the slots. Compact coil ends can be achieved.

### BRIEF DESCRIPTION OF DRAWINGS

FIG. 1A is a plan view of a conductor in a first embodiment;

FIG. 1B is a front view of the conductor in the first embodiment;

FIG. 2 is a perspective view of the conductor;

FIG. 3A is a plan view showing a combination state of the conductor of FIG. 1A and another conductor;

FIG. 3B is a front view showing the combination state of the conductors of FIG. 3A;

FIG. 4 is a perspective view showing the combination state of the conductors of FIG. 3A;

FIG. 5A is a plan view of a first combined conductor;

FIG. 5B is a front view of the first combined conductor;

FIG. 6 is a perspective view of the first combined conductor;

FIG. 7A is a plan view of a second combined conductor;

FIG. 7B is a front view of the second combined conductor;

FIG. 8 is a perspective view of the second combined conductor;

FIG. 9A is a plan view of a conductor assembly including the first and second combined conductors;

FIG. 9B is a front view of the conductor assembly including the first and second combined conductors;

FIG. 10 is a perspective view of the conductor assembly;

FIG. 11 is a view showing arrangement of the first combined conductor in a stator;

FIG. 12 is a view showing an entire shape of a conductor in a second embodiment;

FIG. 13 is a view showing an entire shape of another conductor in the second embodiment;

FIG. 14 is a view showing an entire shape of another conductor in the second embodiment;

FIG. 15 is a view showing an entire shape of another conductor in the second embodiment;

FIG. 16 is a view showing an entire shape of another conductor in the second embodiment;

FIG. 17 is a view showing an entire shape of another conductor in the second embodiment;

FIG. 18 is a view showing an entire shape of another conductor in the second embodiment;

FIG. 19 is a view showing an entire shape of another conductor in the second embodiment;

FIG. 20 is a view showing an entire shape of another conductor in the second embodiment;

FIG. 21 is a view showing an entire shape of another conductor in the second embodiment;

FIG. 22 is a view showing an entire shape of another conductor in the second embodiment;

FIG. 23 is a view showing an entire shape of another conductor in the second embodiment;

FIG. 24 is a three-view diagram of part of the conductor of FIG. 12;

FIG. 25 is a three-view diagram of part of the conductor of FIG. 13;

FIG. 26 is a three-view diagram of part of the conductor of FIG. 14;

FIG. 27 is a three-view diagram of part of the conductor of FIG. 15;

FIG. 28 is a three-view diagram of part of the conductor of FIG. 16;

FIG. 29 is a three-view diagram of part of the conductor of FIG. 17;

FIG. 30A is a plan view of another conductor in the second embodiment;

FIG. 30B is a front view of the conductor of FIG. 30A;

FIG. 31 is a perspective view of the conductor of FIG. 30A;

FIG. 32A is a plan view showing a combined state of the conductor of FIG. 30A and another conductor in the second embodiment;

FIG. 32B is a front view showing the combined state of the conductors of FIG. 32A;

FIG. 33 is a perspective view of the combined state of the conductors of FIG. 32A;

FIG. 34A is a plan view of a first combined conductor in the second embodiment;

FIG. 34B is a front view of the first combined conductor in the second embodiment;

FIG. 35 is a perspective view of the first combined conductor in the second embodiment;

FIG. 36 is an explanatory view showing an overlapping state of the conductors of FIG. 34B;

FIG. 37A is a plan view of a second combined conductor in the second embodiment;

FIG. 37B is a front view of the second combined conductor in the second embodiment;

FIG. 38 is a perspective view of the second combined conductor in the second embodiment;

FIG. 39A is a plan view of a conductor assembly including the first and second combined conductors in overlapping relation in the second embodiment;

FIG. 39B is a front view of the conductor assembly of FIG. 39A;

FIG. 40 is a perspective view of the conductor assembly in the second embodiment;

FIG. 41 is a perspective view of the conductor assembly wound or coiled by one turn in the second embodiment;

FIG. 42 is a perspective view of the conductor assembly wound by five turns in the second embodiment;

FIG. 43 is a front view of a stator in the second embodiment; and

FIG. 44 is a conceptual view showing a case of overlapping two conductors.

### DESCRIPTION OF EMBODIMENTS

A detailed description of a preferred embodiment of a stator and a cage coil embodying the present invention will now be given referring to the accompanying drawings.

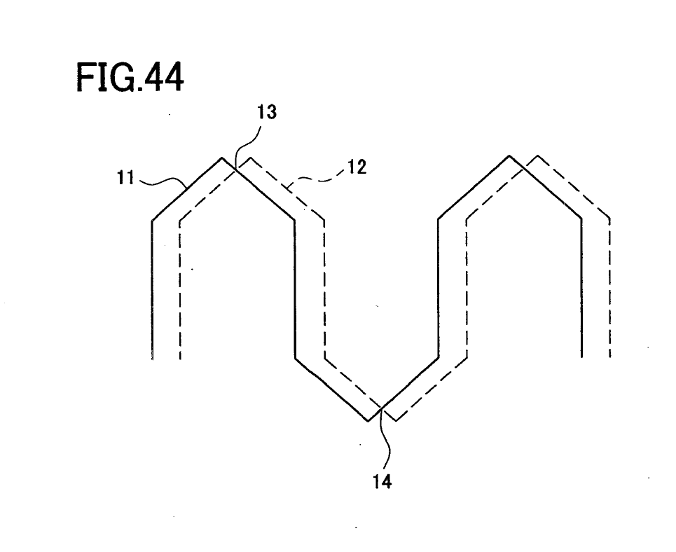

Firstly, a conceptual explanation is given to overlapping of two conductors. FIG. 44 is a conceptual view showing the case of overlapping two conductors (wires) 11 and 12 by displacing them by one slot width. In this case, to combine two conductors so that the portions other than intersecting portions are placed planarly into one, the following configurations are conceivable.

(1) A first configuration is to combine the conductors 11 and 12 in reversed positional relation between the side with a lead wire and the side with no lead wire. Specifically, the conductor 11 is placed on the conductor 12 at an intersecting point 13 located in the side with a lead wire, while the conductor 11 is placed under the conductor 12 at an intersecting point 14 located in the side with no lead wire. This configuration corresponds to the case described in Patent Literature 1 needing the braiding process.

(2) A second configuration is to combine the conductors 11 and 12 in the same positional relation between a side with a lead wire and a side with no lead wire. That is, the conductor 11 is always placed on the conductor 12 at an intersecting point 13 located in the side with a lead wire and also at an intersecting point 14 located in the side with no lead wire. This configuration corresponds to the first embodiment of the present invention.

(3) A third configuration is to combine the conductors 11 and 12 by bending the conductor 12 to detour around the conductor 11 and return to the same plane at an intersecting point 13 located in the side with a lead wire and similarly bending the conductor 12 to detour around the conductor 11 and return to the same plane at an intersecting point 14 located in the side with no lead wire. This configuration corresponds to a second embodiment of the present invention.

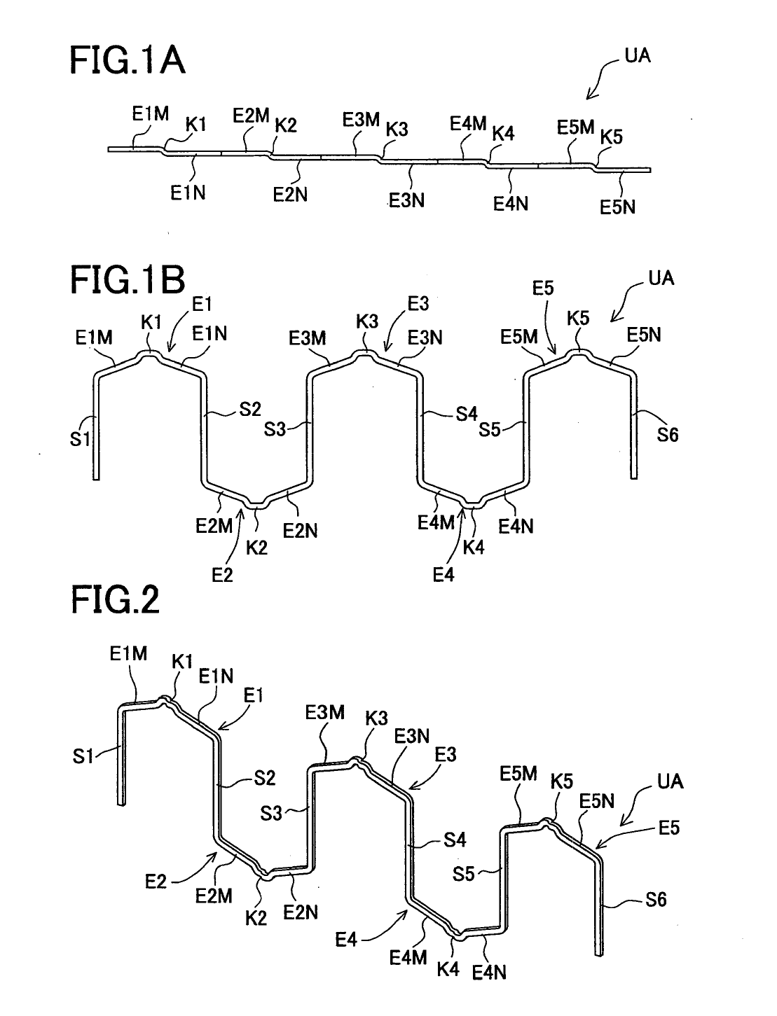

FIGS. 1A and 1B show the shape of a conductor UA (a first conductor of U phase) formed continuously in a zig-zag pattern (a meandering pattern). Specifically, FIG. 1A is a plan view of the conductor UA viewed from above and FIG. 1B is a front view of the conductor UA. FIG. 2 is a perspective view of the conductor UA. FIGS. 1A, 1B, and 2 show only part of the conductor UA, not entirely.

The conductor UA has a zig-zag form continuous from an in-slot portion S1 to be mounted in a slot to an in-slot portion S40 via a connecting portion E1 to be circumferentially placed outside the slot, an in-slot portion S2, a connecting portion E2, . . . , an in-slot portion S5, and a connecting portion E5 and others (in this embodiment, the conductor UA is wound by five turns, each turn (layer) including eight in-slot portions).

Each of the connecting portions E1, E2, . . . is formed with a stepped portion K1, K2, . . . as shown in FIG. 1A. Each stepped portion K (K1, K2, . . . ) is formed with a shoulder having the same size and stepped (bent) in the same direction. The size of the shoulder of each stepped portion K is equal to the thickness of the conductor.

Each connecting portion E1, E2, . . . includes a front part E1M, E2M, . . . and a rear part E1N, E2N, . . . divided by a stepped portion K1, K2, . . . .

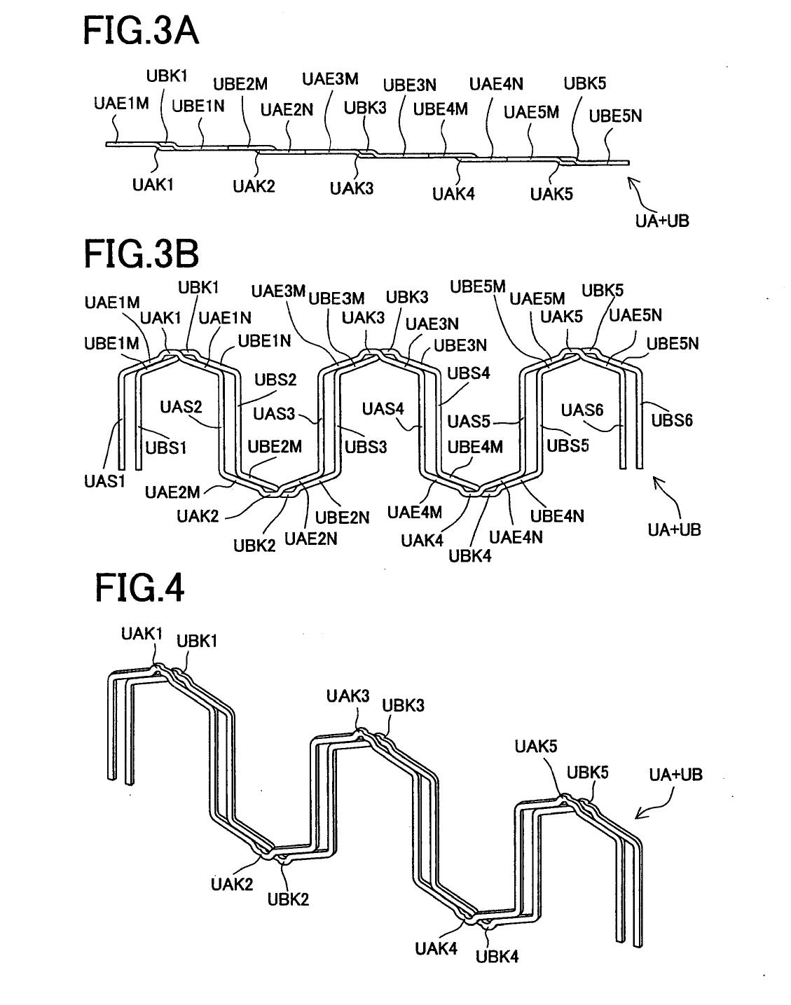

FIGS. 3A and 3B show a combination state of the conductor UA and a conductor UB (a second conductor of U phase); specifically, FIG. 3A is a plan view of the conductors UA and UB viewed from above and FIG. 3B is a front view thereof. FIG. 4 is a perspective view of the conductors UA and UB. FIGS. 3A, 3B, and 4 show part of the conductors UA and UB. The same applies to the other drawings mentioned later. The shape of the conductor UB is the same as that of the conductor UA.

As shown in FIGS. 3A and 4, a first stepped portion UBK1 of the second conductor UB is overlapped in close contact with a first stepped portion UAK1 of the conductor UA but displaced therefrom in a longitudinal direction (i.e., in a lateral direction in the figures, the same applies to the subsequent description). Thus, as shown in FIGS. 3B and 4, a front part UBE1M of the conductor UB is placed under a front part UAE1M of the connecting portion UAE1 of the conductor UA with backward (rightward in the figures) displacement therefrom in the longitudinal direction. Furthermore, a rear part UBE1N of the conductor UB is placed on top of a rear part UAE1N of the conductor UA with displacement therefrom in the longitudinal direction. Between before and behind the stepped portion UAK1 and the stepped portion UBK1, the conductors UA and UB are reversed in positional relation in a vertical direction in FIG. 3B. The conductors UA and UB have the same width in the vertical direction.

A second stepped portion UBK2 of the conductor UB is overlapped in close contact with a second stepped portion UAK2 of the conductor UA and displaced therefrom in the longitudinal direction. In a connecting portion E2, a front part UBE2M of the conductor UB is placed on top of a front part UAE2M of the connecting portion UAE2 of the conductor UA with displacement therefrom in the longitudinal direction. A rear part UBE2N of the conductor UB is placed under a rear part UAE2N of the conductor UA with displacement therefrom in the longitudinal direction. In other words, between before and behind the stepped portions UAK2 and UBK2, the conductors UA and UB are reversed in positional relation in the vertical direction.

Similarly, a third stepped portion UBK3 of the conductor UB is overlapped in contact with a third stepped portion UAK3 of the conductor UA with displacement therefrom in the longitudinal direction. A fourth stepped portion UBK4 of the conductor UB is overlapped in contact with a fourth stepped portion UAK4 of the conductor UA with displacement therefrom longitudinal direction. A fifth stepped portion UBK5 of the conductor UB is overlapped in contact with a fifth stepped portion UAK5 of the conductor UA with displacement therefrom in the longitudinal direction. At each overlapping place, the positional relation of the conductors UA and UB is changed reversely in the vertical direction. A first in-slot portion UAS1 of the conductor UA and a first in-slot portion UBS1 of the conductor UB are spaced from each other at a distance corresponding to the width of a slot.

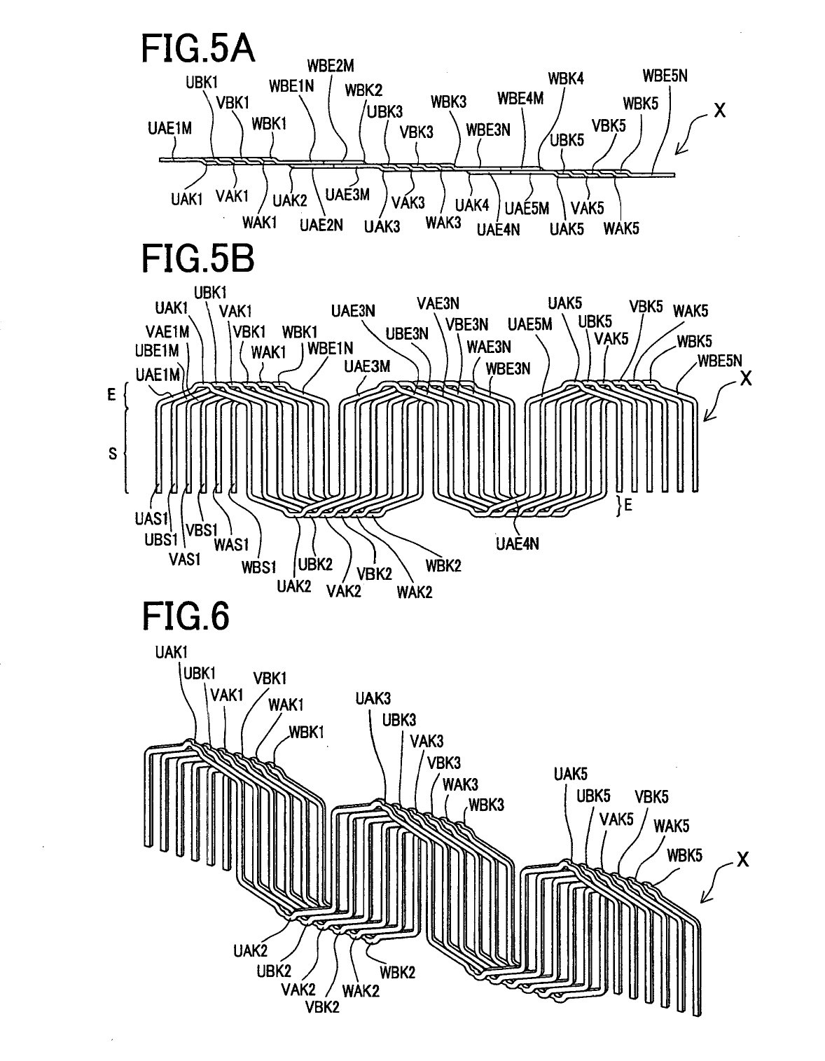

FIGS. 5A and 5B show a first combined conductor X obtained by combining six conductors; the conductor UA (a first conductor of U phase), the conductor UB (a second conductor of U phase), a conductor VA (a first conductor of V phase), a conductor VB (a second conductor of V phase), a conductor WA (a first conductor of W phase), and a conductor WB (a second conductor of W phase). The conductors UA, UB, VA, VB, WA, and WB have the same shape excepting respective end portions.

FIG. 5A is a plan view of the combined conductor X viewed from above and FIG. 5B is a front view thereof. FIG. 6 is a perspective view of the first combined conductor X. FIGS. 5A, 5B, and 6 show only part of the first combined conductor X.

As shown FIGS. 5A and 6, the stepped portion UAK1 of the conductor UA, the stepped portion UBK1 of the conductor UB, a stepped portion VAK1 of the conductor VA, a stepped portion VBK1 of the conductor VB, a stepped portion WAK1 of the conductor WA, and a stepped portion WBK1 of the conductor WB are placed one on another sequentially with displacement in the longitudinal direction. As shown in FIGS. 5B and 6, accordingly, the front part UAE1M of the conductor UA, the front part UBE1M of the conductor UB, a front part VAE1M of the conductor VA, a front part VBE1M of the conductor VB, a front part WAE1M of the conductor WA, and a front part WBE1M of the conductor WB are placed one under another sequentially with displacement in the longitudinal direction. Behind each stepped portion K, a rear part UAE1N of the conductor UA, a rear part UBE1N of the conductor UB, a rear part VAE1N of the conductor VA, a rear part VBE1N of the conductor VB, a rear part WAE1N of the conductor WA, and a rear part WBE1N of the conductor WB are placed one on another sequentially with displacement in the longitudinal direction.

In other words, between before and behind the stepped portions UAK1, UBK1, VAK1, VBK1, WAK1, and WBK1, rear parts EN of the conductors UA, UB, VA, VB, WA, and WB are arranged in reversed positional relation from front parts EM of the conductors UA, UB, VA, VB, WA, and WB.

In the connecting portion E2, front parts UAE2M, UBE2M, VAE2M, VBE2M, WAE2M, and WBE2M are placed one on another sequentially with displacement in the longitudinal direction.

Behind a stepped portion K2, rear parts UAE2N, UBE2N, VAE2N, VBE2N, WAE2N, and WBE2N are placed one under another sequentially with displacement in the longitudinal direction.

In connecting portions E3, E4 and subsequent connecting portions, similarly, between before and behind stepped portions K3, K4 and subsequent stepped portions, the rear parts EN (E3N, E4N, . . . ) of the conductors UA, UB, VA, VB, WA, WB are reversed in vertical position from the front parts EM (E3M, E4M, . . . ) of the conductors UA, UB, VA, VB, WA, WB.

In the first combined conductor X, each in-slot portion S (S1, S2, . . . ) is a single conductor segment without overlapping another conductor segment and each connecting portion E (E1, E2, . . . ) includes two conductor segments overlapping each other, as shown in FIG. 5A.

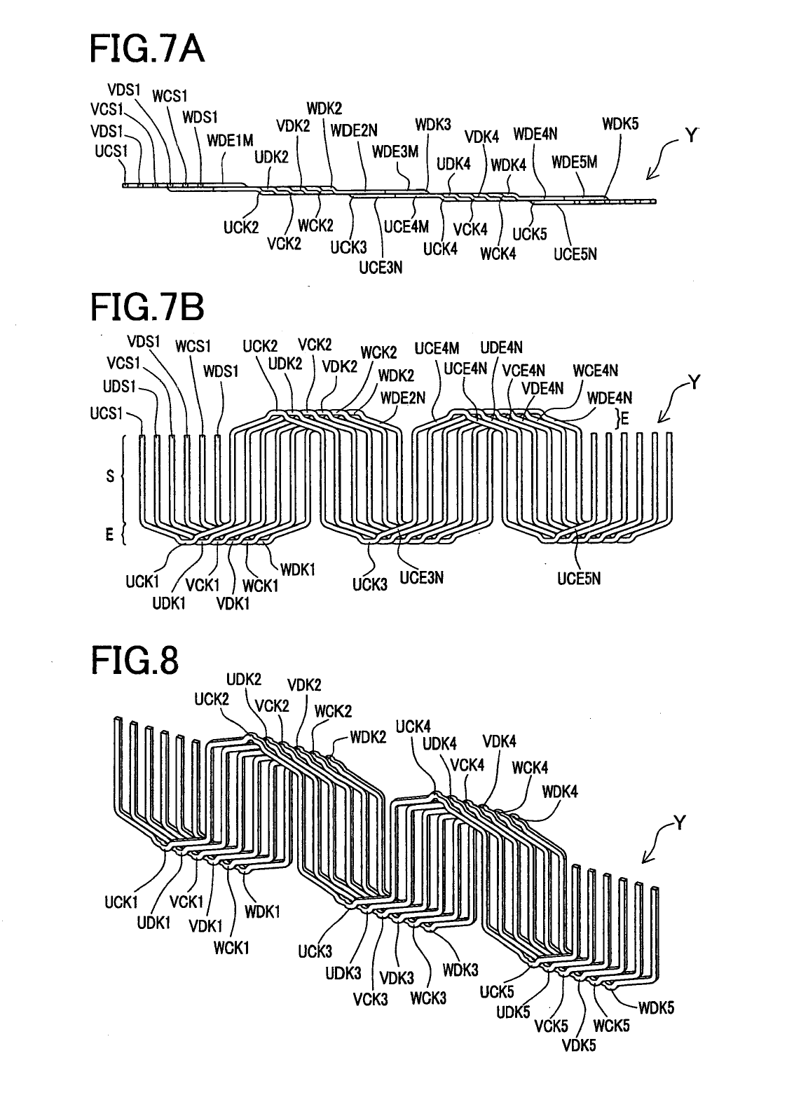

Next, a second combined conductor Y is explained with reference to FIGS. 7A, 7B, and 8. A basic configuration of the second combined conductor Y is the same as that of the first combined conductor X and thus the following explanation is focused on differences.

FIGS. 7A and 7B show the second combined conductor Y made of a combination of six conductors; a conductor UC (a third conductor of U phase), a conductor UD (a fourth conductor of U phase), a conductor VC (a third conductor of V phase), a conductor VD (a fourth conductor of V phase), a conductor WC (a third conductor of W phase), and a conductor WD (a fourth conductor of W phase). Those conductors UC, UD, VC, VD, WC, and WD have the same shape excepting end portions.

FIG. 7A is a plan view of the second combined conductor Y viewed from above and FIG. 7B is a front view thereof. FIG. 8 is a perspective view of the second combined conductor Y. FIGS. 7A, 7B, and 8 show only part of the second combined conductor Y. The second combined conductor Y is formed with displacement of one pitch (corresponding to six linear conductor segments) from the first combined conductor X. Accordingly, the second combined conductor Y is in an inverted orientation with respect to the first combined conductor X.

As shown in FIGS. 7A and 8, a stepped portion UCK1 of the conductor UC, a stepped portion UDK1 of the conductor UD, a stepped portion VCK1 of the conductor VC, a stepped portion VDK1 of the conductor VD, a stepped portion WCK1 of the conductor WC, and a stepped portion WDK1 of the conductor WD are placed one on another sequentially with displacement in the longitudinal direction of each conductor. As shown in FIGS. 7B and 8, accordingly, a front part UCE1M of the conductor UC, a front part UDE1M of the conductor UD, a front part VCE1M of the conductor VC, a front part VDE1M of the conductor VD, a front part WCE1M of the conductor WC, and a front part WDE1M of the conductor WD are placed one on another sequentially with displacement in the longitudinal direction. Behind each stepped portion K, a rear part UCE1N of the conductor UC, a rear part UDE1N of the conductor UD, a rear part VCE1N of the conductor VC, a rear part VDE1N of the conductor VD, a rear part WCE1N of the conductor WC, and a rear part WDE1N of the conductor WD are placed one under another sequentially with displacement in the longitudinal direction.

In other words, between before and behind the stepped portions UCK1, UDK1, VCK1, VDK1, WCK1, and WDK1, rear parts EN of the conductors UC, UD, VC, VD, WC, and WD are reversed in vertical positional relation from front parts EM of the conductors UC, UD, VC, VD, WC, and WD.

In a connecting portion E2, front parts UCE2M, UDE2M, VCE2M, VDE2M, WCE2M, and WDE2M are placed one under another sequentially with displacement in the longitudinal direction.

Behind a stepped portion K2, rear parts UCE2N, UDE2N, VCE2N, VDE2N, WCE2N, and WDE2N are placed one on another sequentially with displacement in the longitudinal direction.

In connecting portions E3, E4 and subsequent connecting portions, similarly, the rear parts EN (E3N, E4N, . . . ) of the conductors UC, UD, VC, VD, WC, and WD are arranged in reversed positional relation from the front parts EM (E3M, 34M, . . . ) of the conductors UC, UD, VC, VD, WC, and WD between before and behind the stepped portions K3, K4 and subsequent stepped portions.

In the second combined conductor Y, the in-slot portion S (S1, S2, is a single conductor segment without overlapping another conductor segment. Each connecting portion E (E1, E2, . . . ) includes two conductor segments overlapping each other, as shown in FIG. 7A.

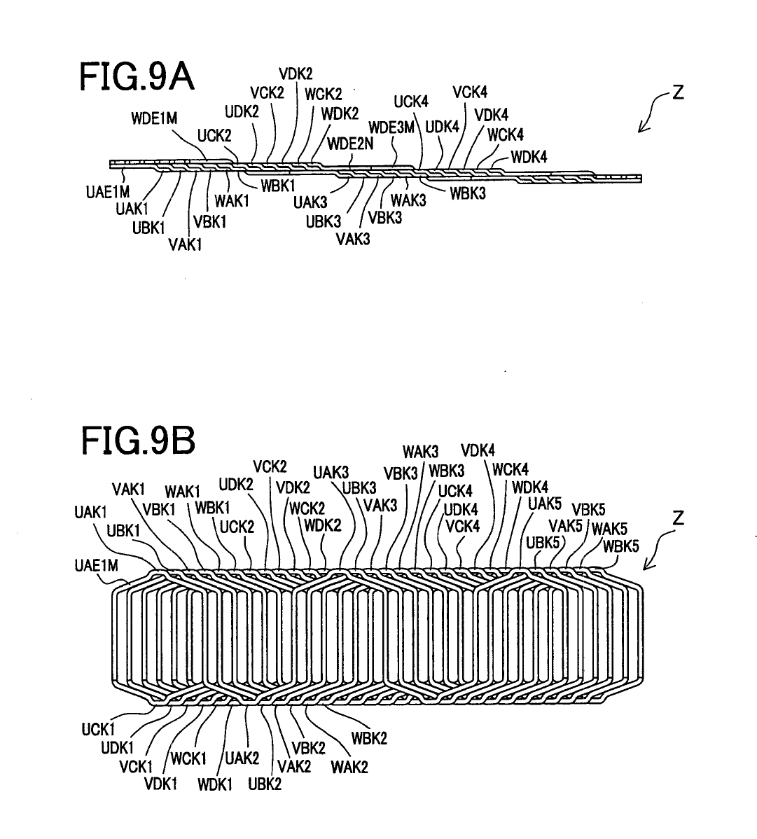

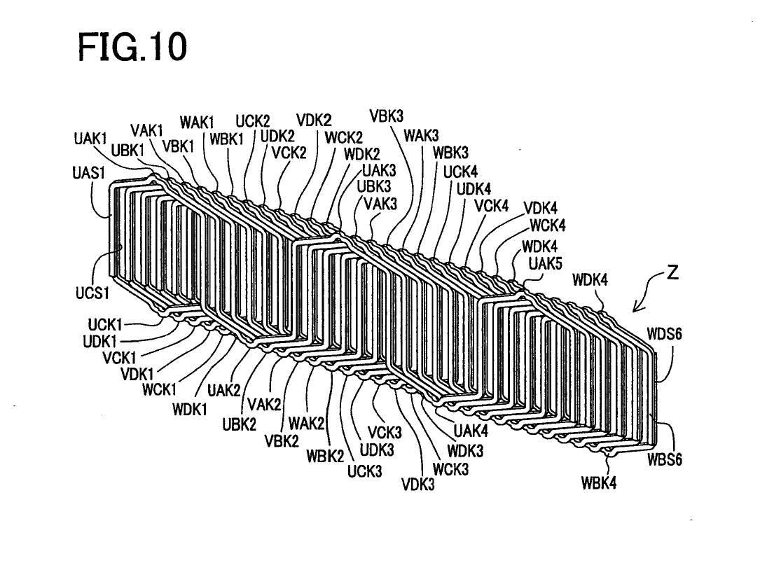

Next, FIGS. 9A, 9B, and 10 show a conductor assembly Z obtained by combining the first and second combined conductors X and Y. Specifically, FIGS. 9A and 9B show that the first combined conductor X is simply placed to overlap the second combined conductor Y; FIG. 9A is a plan view of the conductor assembly Z viewed from above and FIG. 9B is a front view thereof. FIG. 10 is a perspective view of the conductor assembly Z. FIGS. 9A, 9B, and 10 show only part of the conductor assembly Z, not entirely.

The conductors UA and UC constitute a U-phase first rectangular coil. The conductors UB and UD constitute a U-phase second rectangular coil. The conductors VA and VC constitute a V-phase first rectangular coil. The conductors VB and VD constitute a V-phase second rectangular coil. The conductors WA and WC constitute a W-phase first rectangular coil. Furthermore, the conductors WB and WD constitute a W-phase second rectangular coil.

As shown in FIG. 10, the first in-slot portion S includes the first in-slot portion UAS1 of the conductor UA and the first in-slot portion UCS1 of the conductor UC that overlap each other. Similarly, each of the subsequent in-slot portions includes two overlapping in-slot portions S.

On the other hand, each connecting portion of the first . combined conductor X and each connecting portion of the second combined conductor Y are located in positions not interfering with each other. Accordingly, when the combined conductors X and Y are combined, each connecting portion includes two overlapping conductor segments.

In other words, in an upper part of the conductor assembly Z, the stepped portions K, i.e., twelve stepped portions UAK1, UBK1, VAK1, VBK1, WAK1, WBK1, UCK2, UDK2, VCK2, VDK2, WCK2, and WDK2 are placed overlapping one another sequentially with displacement in the longitudinal direction of the conductor assembly Z. Furthermore, the front parts EM, i.e., twelve front parts UAE1M, UBE1M, VAE1M, VBE1M, WAE1M, WBE1M, UCE2M, UDE2M, VCE2M, VDE2M, WCE2M, and WDE2M are placed one under another with displacement in the longitudinal direction. The rear parts EN, i.e., twelve rear parts UAE1N, UBE1N, VAE1N, VBE1N, WAE1N, WBE1N, UCE2N, UDE2N, VCE2N, VDE2N, WCE2N, and WDE2N are placed one on another sequentially with displacement in the longitudinal direction.

The vertical positional relation of the rear parts EN of the conductors is reversed from that of the front parts EM of the conductors between before and behind (in the figures, on the right and left of) the stepped portions UK, i.e., UAK1, UBK2, VAK1, VBK1, WAK1, WBK1, UCK2, UDK2, VCK2, VDK2, WCK2, and WDK2.

In a lower part of the conductor assembly Z, the stepped portions K, i.e., twelve stepped portions UCK1, UDK1, VCK1, VDK1, WCK1, WDK1, UAK2, UBK2, VAK2, VBK2, WAK2, and WBK2 are placed sequentially overlapping one another with displacement in the longitudinal direction of the conductor assembly Z. The front parts EM, i.e., twelve front parts UCE1M, UDE1M, VCE1M, VDE1M, WCE1M, WDE1M, UAE2M, UBE2M, VAE2M, VBE2M, WAE2M, and WBE2M are placed sequentially one on another with displacement in the longitudinal direction. Furthermore, the rear parts EN, i.e., twelve rear parts UCE1N, UDE1N, VCE1N, VDE1N, WCE1N, WDE1N, UAE2N, UBE2N, VAE2N, VBE2N, WAE2N, and WBE2N are placed sequentially one under another with displacement in the longitudinal direction.

The front parts EM and the rear parts EN of the conductors are reversed in vertical position between before and behind (in the figures, on the right and left of) the stepped portions UK, i.e., UCK1, UDK2, VCK1, VDK1, WCK1, WDK1, UAK2, UBK2, VAK2, VBK2, WAK2, and WBK2.

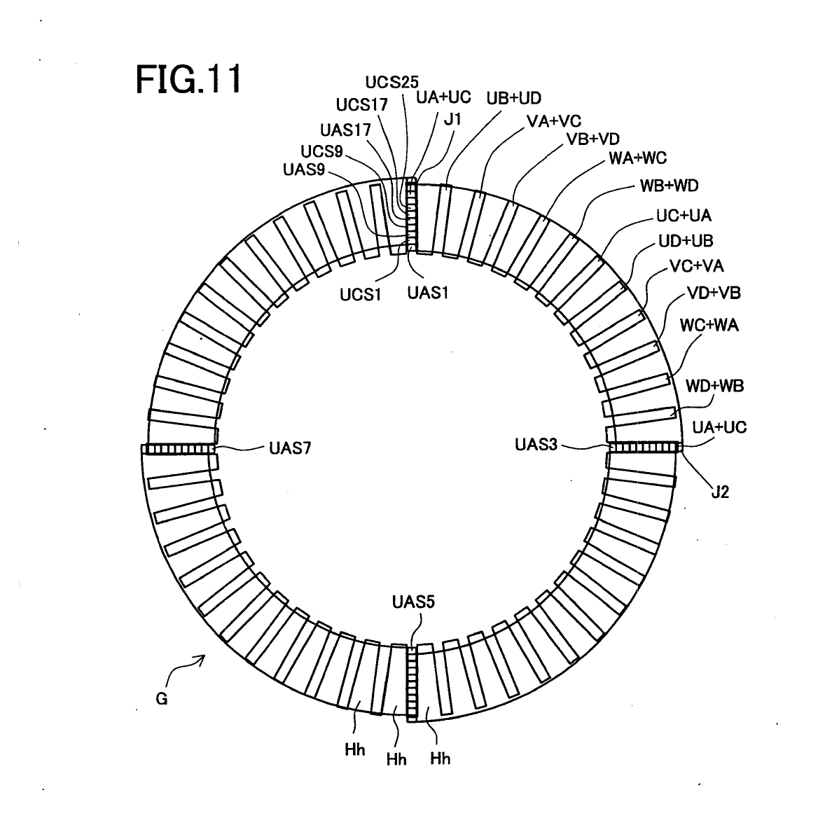

FIG. 11 is a cross sectional view of a stator G, showing the arrangement of conductors in each slot. The stator G in this embodiment has forty-eight slots. The conductor assembly Z includes forty-eight in-slot portions S per one turn (layer). That is, in the slots for holding the U-phase first coil constituted of the conductors UA and UC (UA+UC), eight pairs of in-slot portions are mounted; i.e., UAS1+UCS1, UAS2+UCS2, UAS3+UCS3, UAS4+UCS4, UAS5+UCS5, UAS6+UCS6, UAS7+UCS7, and UAS8+UCS8.

The stator G includes ten in-slot portions in each slot and therefore the conductor assembly Z is wound by five turns. Herein, the coil diameter of each of 2^{nd}, 3^{rd}, and subsequent layers is sequentially increased as compared with the 1^{st} layer and accordingly the length of the connecting portions is also increased sequentially. As shown in FIG. 11, the conductor assembly Z is wound by five turns to provide ten in-slot portions S in each slot.

Herein, the conductor assembly Z is of a stepped shape in the longitudinal direction as shown in FIG. 9A. When the conductor assembly Z is wound by five turns, the outer periphery of the conductor assembly Z wound protrudes outwardly sequentially from a position J1 of an outermost conductor relative to the in-slot portion UAS1 to a position J2 of an outermost conductor relative to the in-slot portion UAS3.

To avoid such defect, it is preferable to plastic deform the in-slot portions S by pressing to provide a circular outer periphery. Thus, the position J2 can be returned to a position concyclic with the position J1. FIG. 11 shows a state of the conductor assembly Z with the position J2 returned to a concyclic position with the position J1 by pressing.

One example of a process of producing the conductors UA, UB, UC, UD, VA, VB, VC, VD, WA, WB, WC, and WD is explained below.

A first step is to bend a coated copper wire having a rectangular cross section into a zig-zag pattern. At that time, for second, third, fourth, and fifth turns, sequentially, the intervals between the in-slot portions S are increased in accordance with the increase in diameter of a wound coil. In a second step, the stepped portions K, the connecting portions E, and others are formed by pressing. The first and second steps are not intended to largely change the cross sectional shape of the coated copper wire. Thus, the coating is not damaged. If the coating could be damaged, the copper wire has only to be coated again. The first and second steps may be conducted in reverse order.

As explained in detail above, the stator G in this embodiment includes the cage coil produced by combining the first combined conductor X having six first conductors UA, UB, VA, VB, WA, WB each formed in continuous zig-zag pattern which are placed sequentially with displacement and the second combined conductor Y having six second conductors UC, UD, VC, VD, WC, WD each formed in continuous zig-zag pattern and placed one another sequentially with displacement from one another, the second combined conductor Y being displaced by one pitch from the first combined conductor X, to form the conductor assembly Z, and winding the conductor assembly Z by five turns. Accordingly, the first conductors UA, UB, VA, VB, WA, WB and the second conductors UC, UD, VC, VD, WC, WD have only to be simply combined without braiding. Consequently, the stator G can provide enhanced production efficiency.

In the case of simply combining, the coils (conductors) are displaced sequentially and thus the outer periphery of a final cage coil could not be circular. In this embodiment, on the other hand, the coil ends have slight allowance to plastic deform the coil set in the slots by pressing to bring the outer periphery thereof into a circular form. Thus, this embodiment could not provide the above defect.

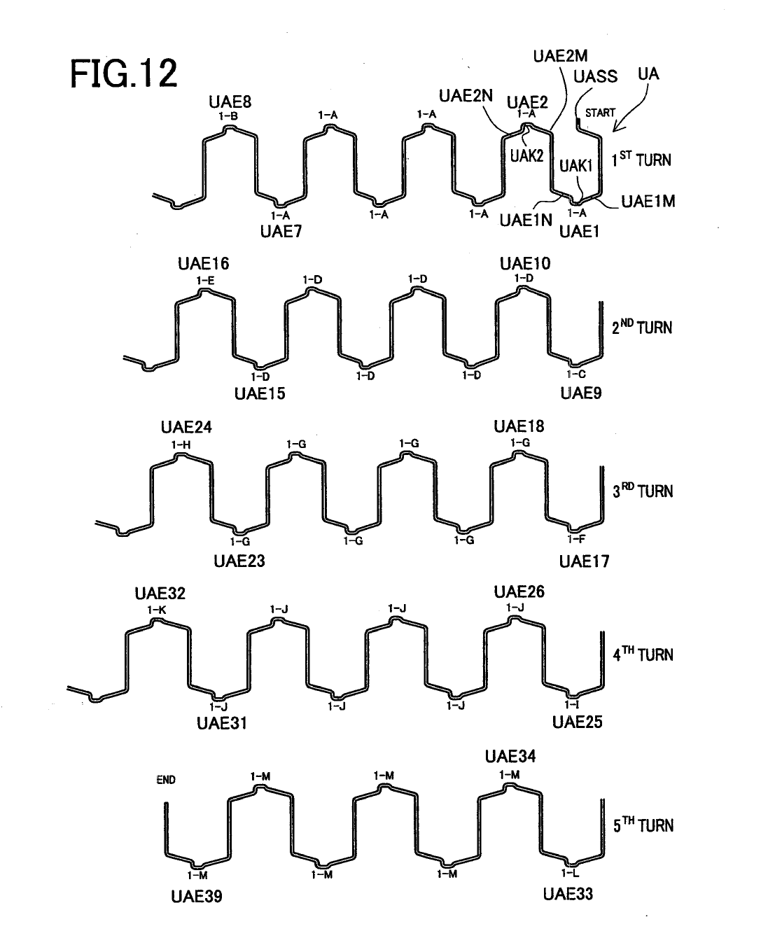

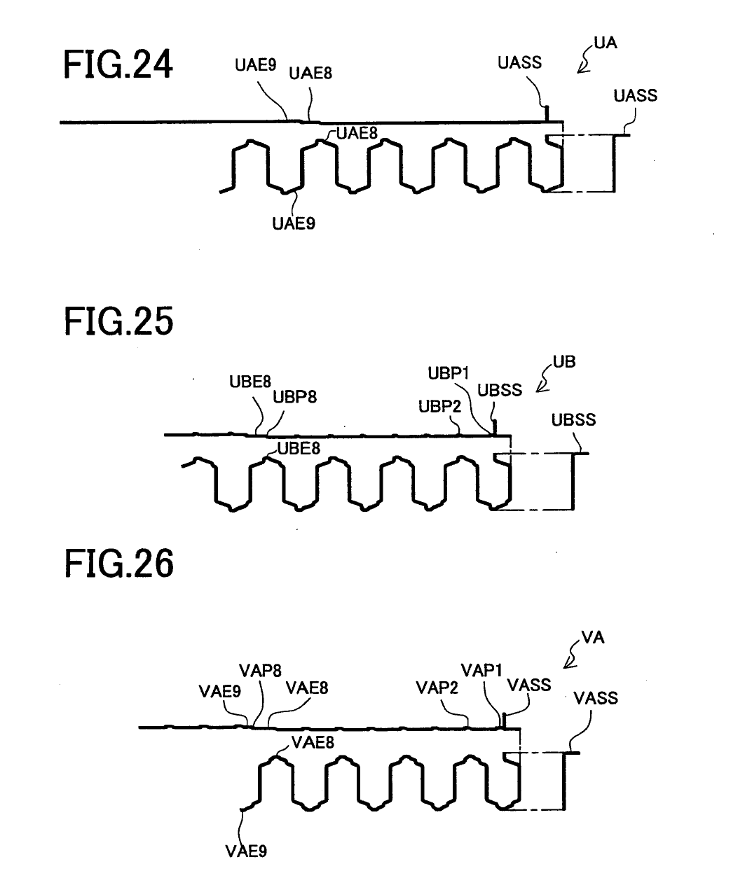

Next, a second embodiment will be described. FIG. 12 is a front view of a conductor UA (a first conductor of U phase) formed in a continuous zig-zag pattern (a meandering pattern). FIG. 24 is a three-view diagram of the conductor UA for the first turn (layer). Actually, the conductor UA is continuous throughout the length thereof for first to fifth turns (layers) but illustrated in separate stages in FIG. 12. The second and subsequent turns (layers) are to be located outside the first and subsequent turns (layers).

In the figures, the signs 1-A, 1-B, 1-C, 1-D, 1-E, 1-F, 1-G, 1-H, 1-I, 1-J, 1-K, 1-L, and 1-M represent the types of shapes of connecting portions. The connecting portions with the same signs have the same shape.

A winding start portion UASS for the first turn extends outside at the right (outwardly in a radial direction of a stator) in a right side view as shown in FIG. 24. The connecting portions UAE1 to UAE8 for the first turn have the same shape in a front view of FIG. 12. Each of the connecting portions UAE1, UAE2, . . . is formed at the center with a stepped portion UAK1, UAK2, A front part UAE1M is positioned on an outer side than a rear part UAE1N. The connecting portions UAE1 to UAE7 are flat when viewed from above as in plan view of FIG. 24. As shown in FIG. 24, the rear part UAE8N and the front part UAE9M are formed with a pair of steps for lane change from the first turn to the second turn.

The connecting portions UAE9 to UAE16 for a second turn have the same shape in a front view of FIG. 12. The length of each of the connecting portions UAE9 to UAE16 for the second turn is designed to be longer than that of each of the connecting portions UAE1 to UAE8 for the first turn because the diameter of a wound coil of the second turn (layer) is larger than that of the first turn (layer). The connecting portions UAE 10 to UAE 15 are flat in a plan view as with those for the first turn. A rear part UAE16N and a front part UAE17M are formed with a pair of steps for lane change from the second turn to the third turn.

The connecting portions for third to fifth turns are similar in configuration to above and thus their explanations are not repeated herein.

In the second embodiment, as in the first embodiment, the stator G also has the cross sectional shape shown in FIG. 11. The stator G in the second embodiment has forty-eight slots. Six conductors UA, UB, VA, VB, WA, and WB are provided. Accordingly, a wound coil of the first turn of each conductor has eight in-slot portions S.

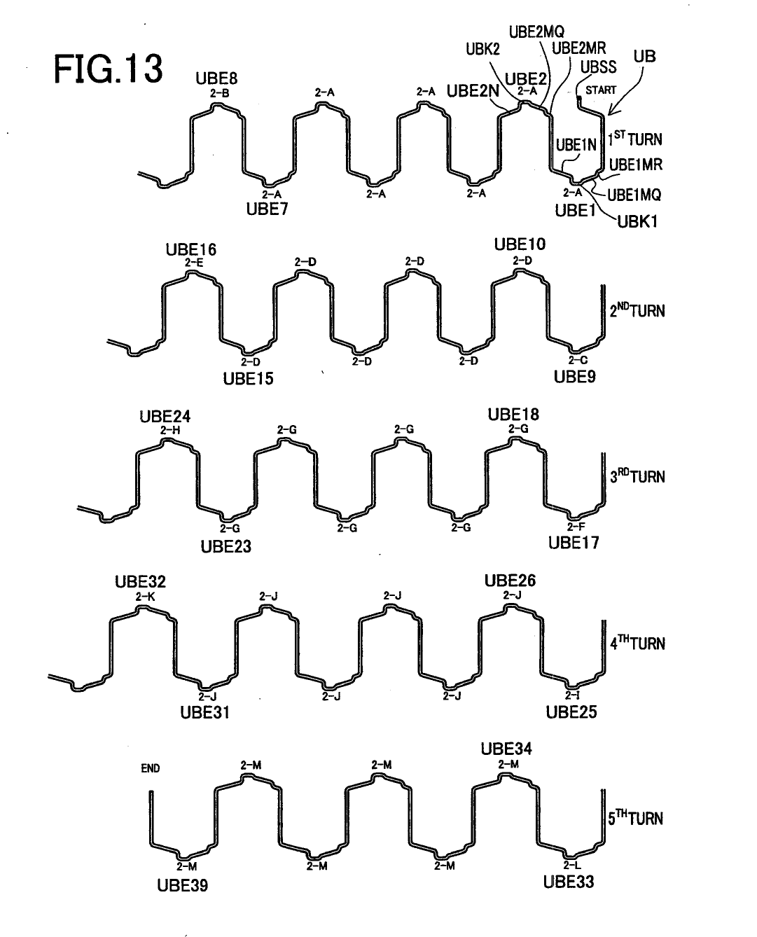

FIG. 13 is a front view of the conductor UB (a second conductor of U phase) formed in a zig-zag pattern. FIG. 25 is a three-view diagram of the conductor UB for the first turn (layer). The conductor UB is actually continuous throughout the length thereof for first to fifth turns (layers) but illustrated in separate stage in FIG. 13. The second and subsequent turns (layers) are to be located outside the first and subsequent turns (layers).

In the figures, the signs 2-A, 2-B, 2-C, 2-D, 2-E, 2-F, 2-G, 2-H, 2-I, 2-J, 2-K, 2-L, and 2-M represent the types of shapes of connecting portions. The connecting portions with the same signs have the same shape.

A winding start portion UBSS for the first turn extends outside at the right (outwardly in the radial direction of the stator) in a right side view as shown in FIG. 25. The connecting portions UBE1 to UBE8 for the first turn have the same shape in a front view of FIG. 13. Each of the connecting portions UBE1, UBE2, . . . is formed at the center with a stepped portion UBK1, UBK2, . . . Each front part UBE1M, UBE2M, . . . includes a stair portion UBE1MR, UBE2MR, . . . and a stair portion UBE1MQ, UBE2MQ, . . . . Herein, a stair portion located on a near side to the stepped portion K is indicated by a sign ending in Q and a stair portion located on a far side from the stepped portion K is indicated by a sign ending in R.

The connecting portions UBE1 to UBE7 are formed with detour portions UBP1 to UBP7 each having a recessed shape at the positions of the stepped portions UBK1 to UBK7 as shown in plan view of FIG. 25. A detour portion UBP8 of the connecting portion UBE8 continuing from the first turn to the second turn has only one step (shoulder) without returning, for lane change from the first turn to the second turn. Thus, the detour portion UBP8 is not of a recessed shape.

Connecting portions UBE9 to UBE16 for the second turn have the same shape in front view of FIG. 13. The length of the connecting portions UBE9 to UBE16 for the second turn is longer than the length of the connecting portions UBE1 to UBE8 for the first turn because the diameter of a coil of the second turn is larger than that of the coil of the first turn. As with those for the first turn, the connecting portions UBE9 to UBE15 are formed with detour portions UBP9 to UBP15 each having a recessed shape at the positions of stepped portions UBK9 to UBK15. The width of the recess of each detour portion UBP9 to UBP15 is enough to receive the conductor UA, i.e., is equal to or larger than the width of the conductor (wire) UA.

A detour portion UBP16 of the connecting portion UBE16 continuing from the second turn to the third turn has only one step (shoulder) without returning, for lane change from the second turn to the third turn. Thus, the detour portion UBP16 is not of a recessed shape. The same configuration applies to the third to fifth turns and hence their explanations are not repeated herein.

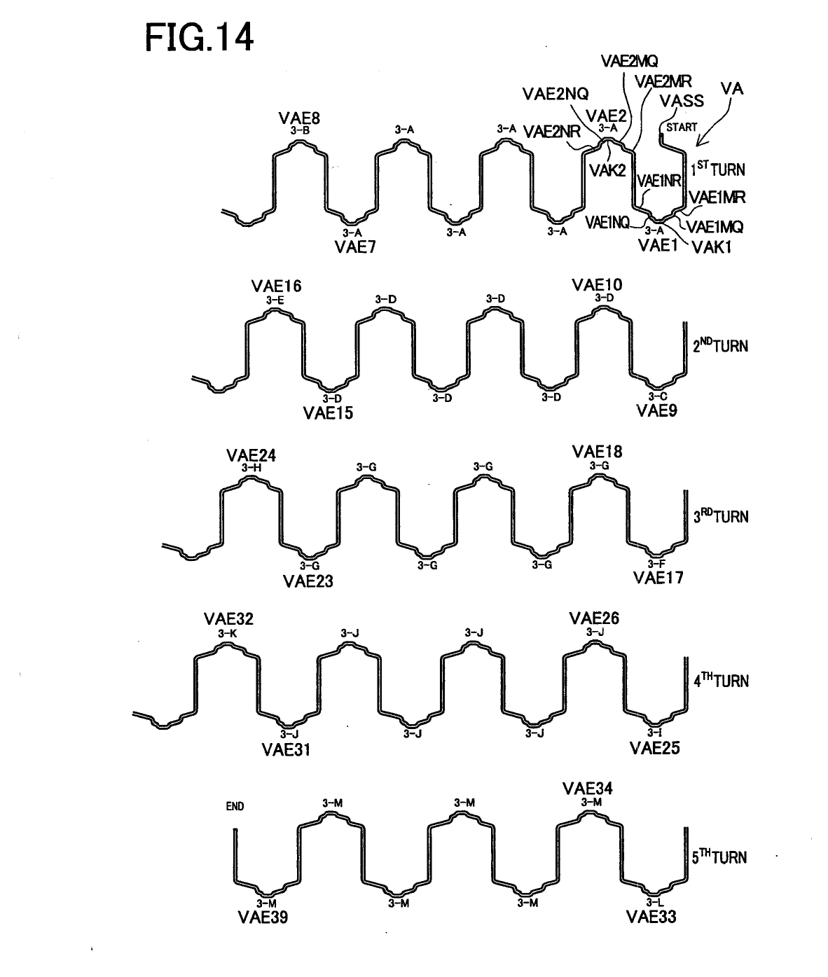

FIG. 14 is a front view of the conductor VA (a first conductor of V phase) formed in a zig-zag pattern. FIG. 26 is a three-view diagram of the conductor VA for the first turn (layer). The conductor VA is actually continuous throughout the length thereof for first to fifth turns (layers) but illustrated in separate stages in FIG. 14. The second and subsequent turns (layers) are to be located outside the first and subsequent turns (layers).

In the figures, the signs 3-A, 3-B, 3-C, 3-D, 3-E, 3-F, 3-G, 3-H, 3-I, 3-J, 3-K, 3-L, and 3-M represent the types of shapes of connecting portions. The connecting portions with the same signs have the same shape.

A winding start portion VASS for the first turn extends outside at the right (outwardly in the radial direction of the stator) in a right side view as shown in FIG. 26. The connecting portions VAE1 to VAE8 for the first turn have the same shape in a front view of FIG. 14. Each of the connecting portions VAE1, VAE2, . . . is formed at the center with a stepped portion VAK1, VAK2,

Each front part VAE1M, VAE2M, . . . includes a stair portion VAE1MR, VAE2MR, and a stair portion VAE1MQ, VAE2MQ, . . . . Each rear part VAE1N, VAE2N, . . . includes a stair portion VAE1NR, VAE2NR, . . . and a stair portion VAE1NQ, VAE2NQ, . . . Herein, a stair portion located on a near side to the stepped portion K is indicated by a sign ending in Q and a stair portion located on a far side from the stepped portion. K is indicated by a sign ending in R.

The connecting portions VAE1 to VAE7 are formed with detour portions VAP1 to VAP7 each having a recessed shape at the positions of the stepped portions VAK1 to VAK7 as shown in plan view of FIG. 26. The width of the recess of each detour portion VAP1 to VAP7 is enough to receive the conductors UA and UB, i.e., is equal to or larger than the widths (total width) of the conductors UA and UB. A detour portion VAP8 of the connecting portion VAE8 continuing from the first turn to the second turn has only one step (shoulder) without returning, for lane change from the first to second turns. Thus, the detour portion VAP8 is not of a recessed shape. The configurations of the second and subsequent turns are the same as those of the conductor UB and their explanations are not repeated herein.

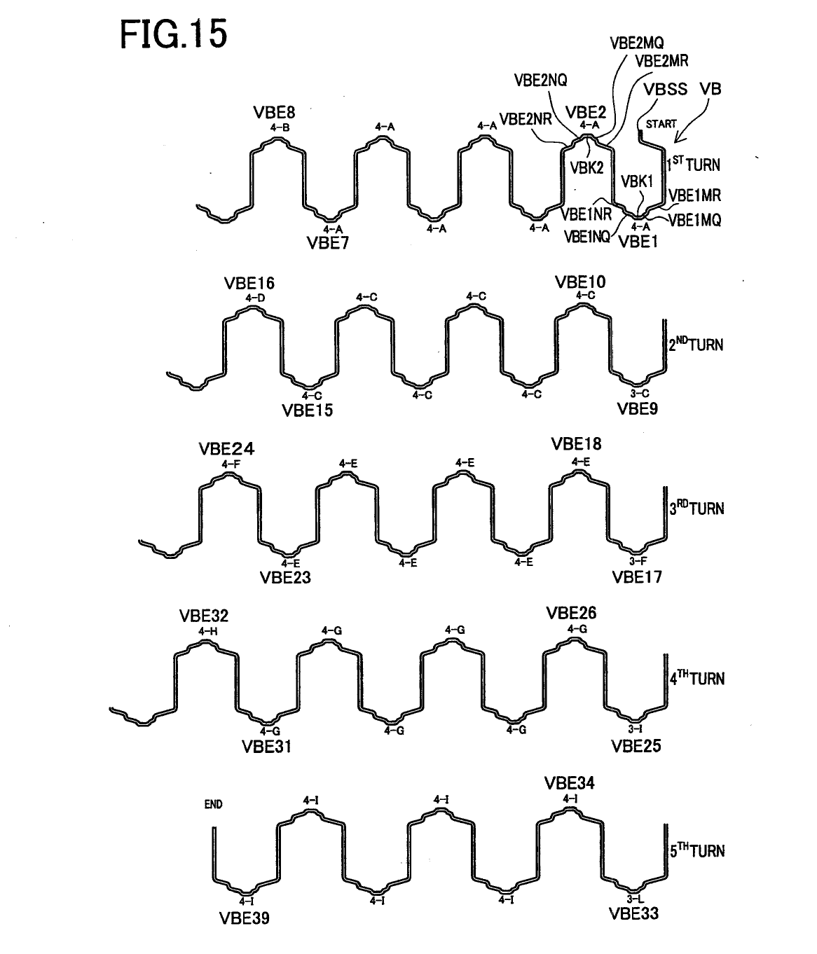

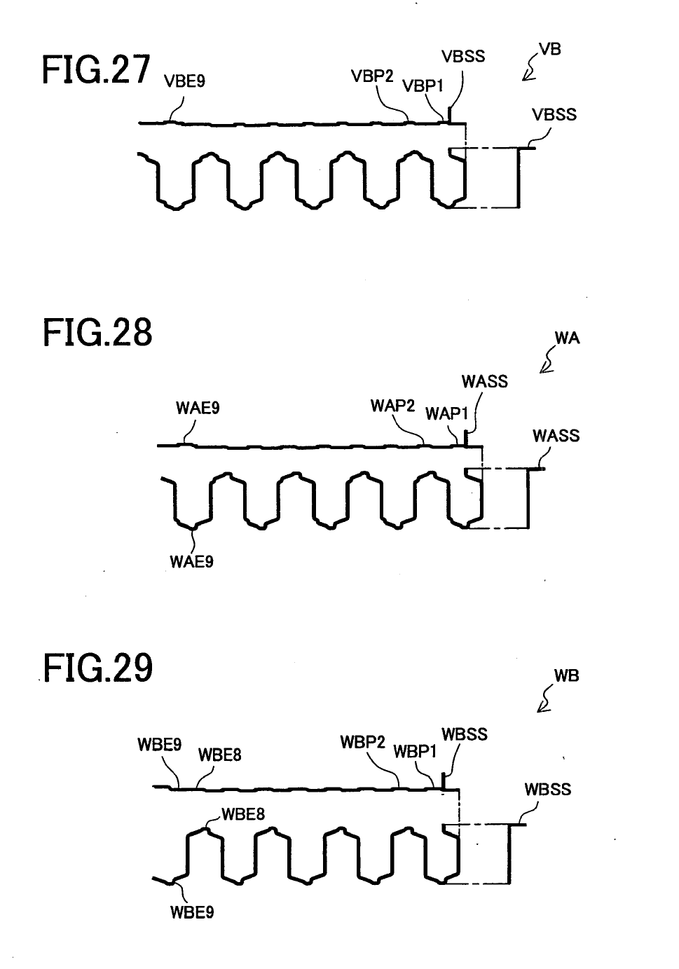

FIG. 15 is a front view of the conductor VB (a second conductor of V phase) formed in a zig-zag pattern. FIG. 27 is a three-view diagram of the conductor VB for the first turn (layer). In the figures, the signs 4-A, 4-B, 4-C, 4-D, 4-E, 4-F, 4-G, 4-H, and 4-I represent the types of shapes of connecting portions. The connecting portions with the same signs have the same shape.

A winding start portion VBSS for the first turn extends outside at the right (outwardly in the radial direction of the stator) in a right side view as shown in FIG. 27. The connecting portions VBE1 to VBE8 for the first turn have the same shape in a front view of FIG. 15. Each of the connecting portions VBE1, VBE2, . . . is formed at the center with a stepped portion VBK1, VBK2, . . . . Each rear part VBE1N, VBE2N, . . . includes a stair portion VBE1NR, VBE2NR, . . . and a stair portion VBE1NQ, VBE2NQ, . . . .

The connecting portions VBE1 to VBE7 are formed with detour portions VBP1 to VBP7 each having a recessed shape at the positions of the stepped portions VBK1 to VBK7 as shown in plan view of FIG. 27. The width of the recess of each detour portion VBP1 to VBP7 is enough to receive the conductors UA, UB, and VA, i.e., is equal to or larger than the widths (total width) of the conductors UA, UB, and VA. The configurations of the second and subsequent turns are the same as those of the conductor UB and their explanations are not repeated herein.

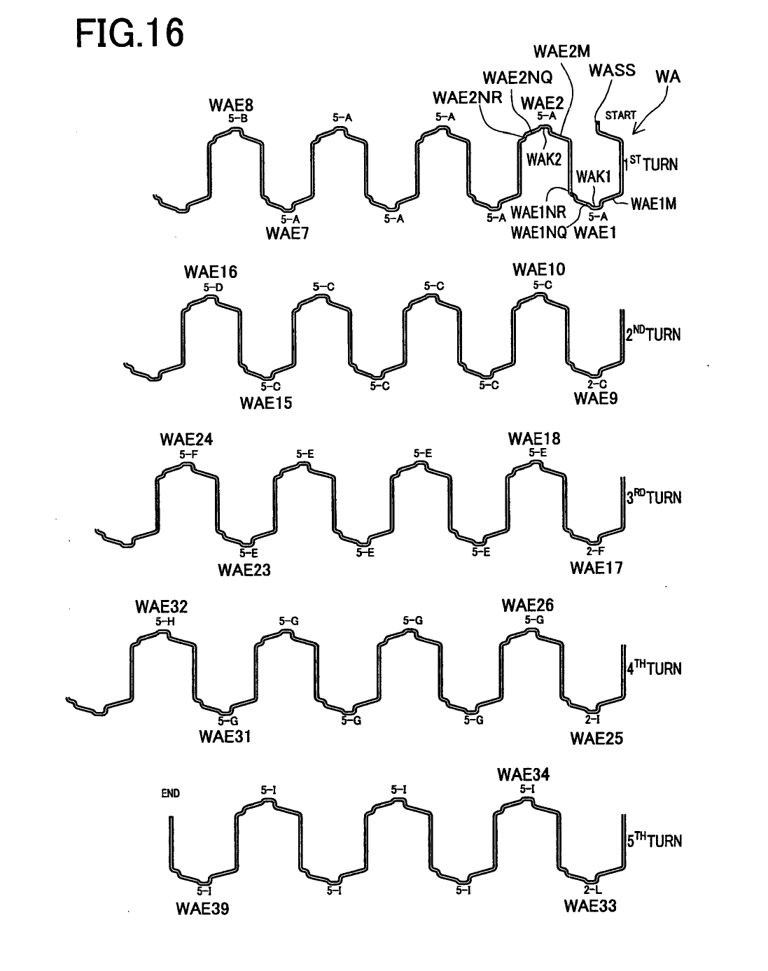

FIG. 16 is a front view of the conductor WA (a first conductor of W phase) formed in a zig-zag pattern. FIG. 28 is a three-view diagram of the conductor WA for the first turn. In the figures, the signs 5-A, 5-B, 5-C, 5-D, 5-E, 5-F, 5-G, 5-H, and 5-I represent the types of shapes of connecting portions. The connecting portions with the same signs have the same shape.

A winding start portion WASS for the first turn extends outside at the right (outwardly in the radial direction of the stator) in a right side view as shown in FIG. 28. The connecting portions WAE1 to WAE8 for the first turn have the same shape in a front view of FIG. 16. Each of the connecting portions WAE1, WAE2, . . . , is formed at the center with a stepped portion WAK1, WAK2, . . . . Each rear part WAE1N, WAE2N, . . . includes a stair portion WAE1NR, WAE2NR, . . . and a stair portion WAE1NQ, WAE2NQ, . . . .

The connecting portions WAE1 to WAE7 are formed with detour portions WAP1 to WAP7 each having a recessed shape at the positions of the stepped portions WAK1 to WAK7 as shown in plan view of FIG. 28. The width of the recess of each detour portion WAP1 to WAP7 is enough to receive the conductors UA, UB, VA, and VB, i.e., is equal to or larger than the widths (total width) of the conductors UA, UB, VA, and VB. The configurations of the second and subsequent turns are the same as those of the conductor UB and their explanations are not repeated herein.

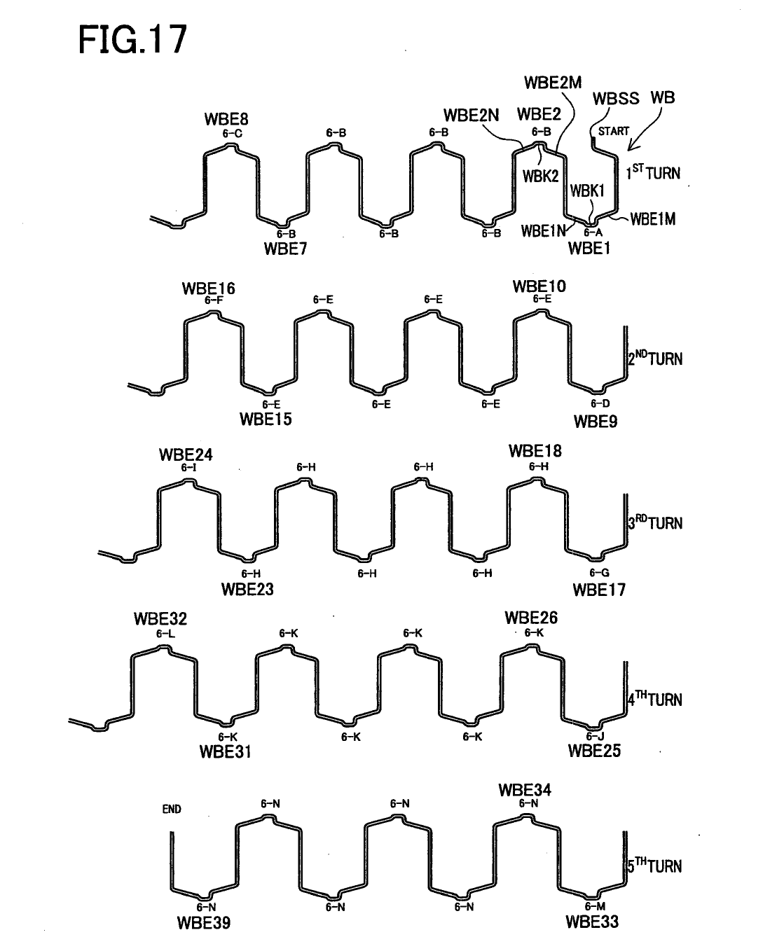

FIG. 17 is a front view of the conductor WB (a second conductor of W phase) formed in a zig-zag pattern. FIG. 29 is a three-view diagram of the first turn of the conductor WB. In the figures, the signs 6-A, 6-B, 6-C, 6-D, 6-E, 6-F, 6-G, 6-H, 6-I, 6-J, 6-K, 6-L, 6-M, and 6-N represent the types of shapes of connecting portions. The connecting portions with the same signs have the same shape.

A winding start portion WBSS for the first turn extends outside at the right (outwardly in the radial direction of the stator) in a right side view as shown in FIG. 29. The connecting portions WBE1 to WBE8 for the first turn have the same shape in a front view of FIG. 17. Each of the connecting portions WBE1, WBE2, . . . , is formed at the center with a stepped portion WBK1, WBK2, . . .

The connecting portions WBE1 to WBE7 are formed with detour portions WBP1 to WBP7 each having a recessed shape at the positions of the stepped portions WBK1 to WBK7 as shown in plan view of FIG. 29. The width of the recess of each detour portion WBP1 to WBP7 is enough to receive the conductors UA, UB, VA, VB, and. WA, i.e., is equal to or larger than the widths (total width) of the conductors UA, UB, VA, VB, and WA. The configurations of the second and subsequent turns are the same as those of the conductor UA and their explanations are not repeated herein.

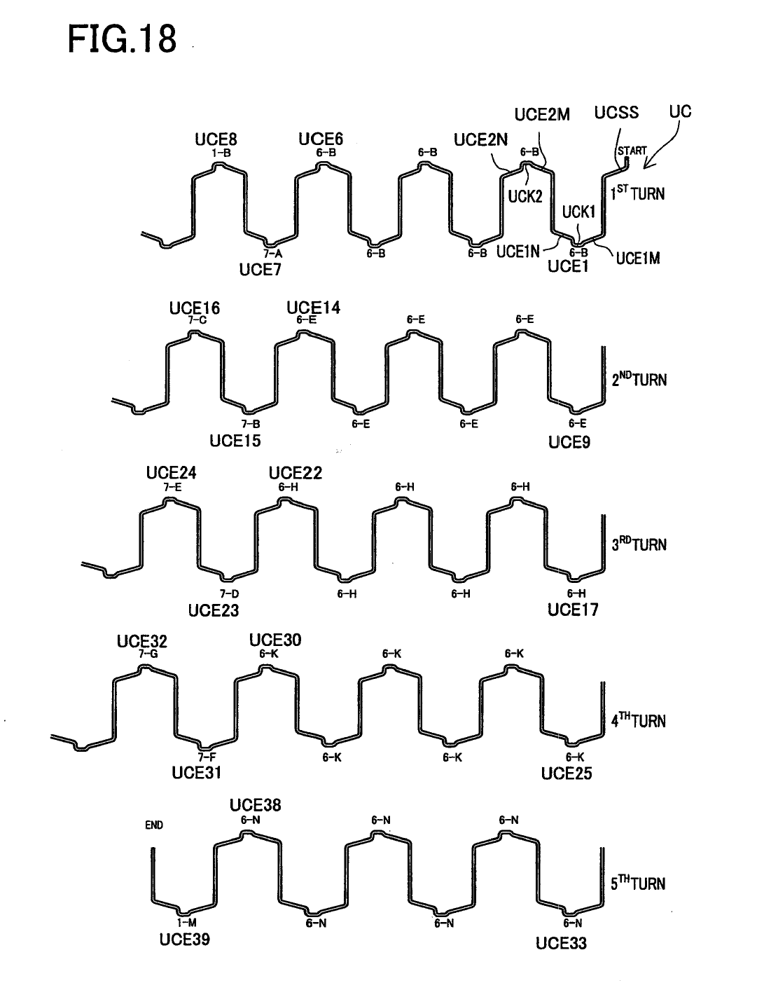

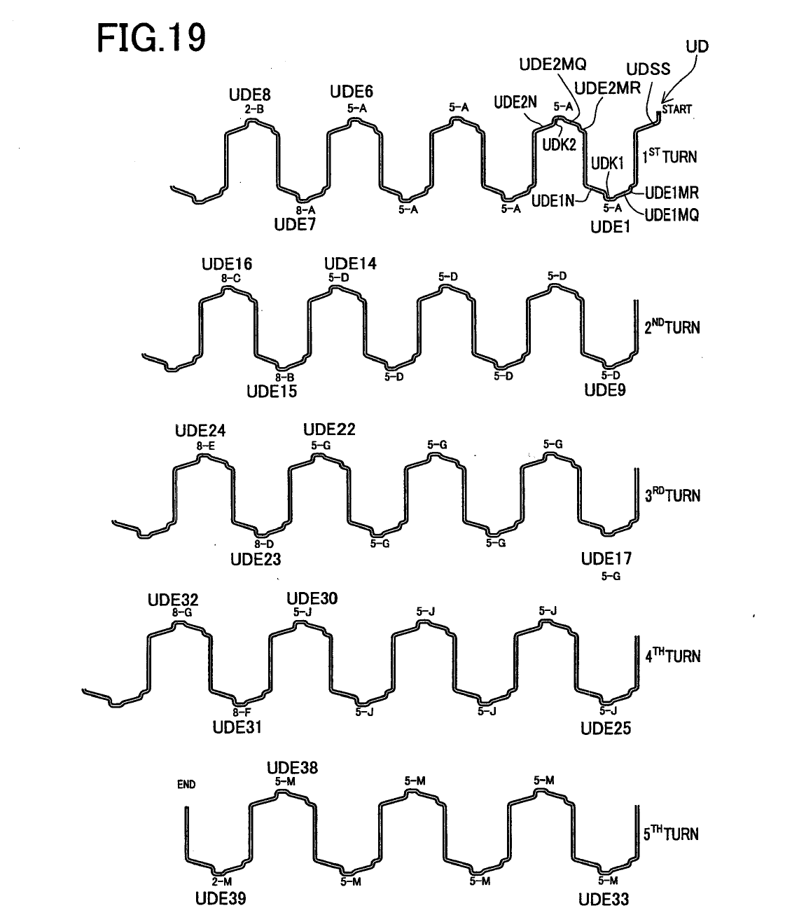

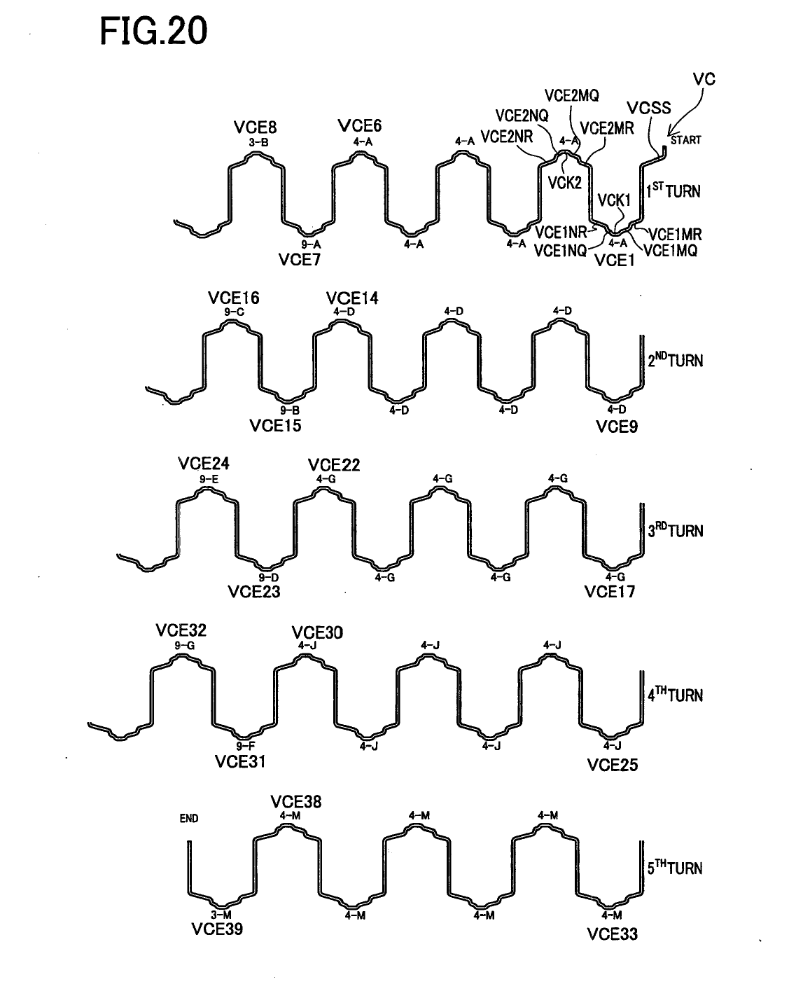

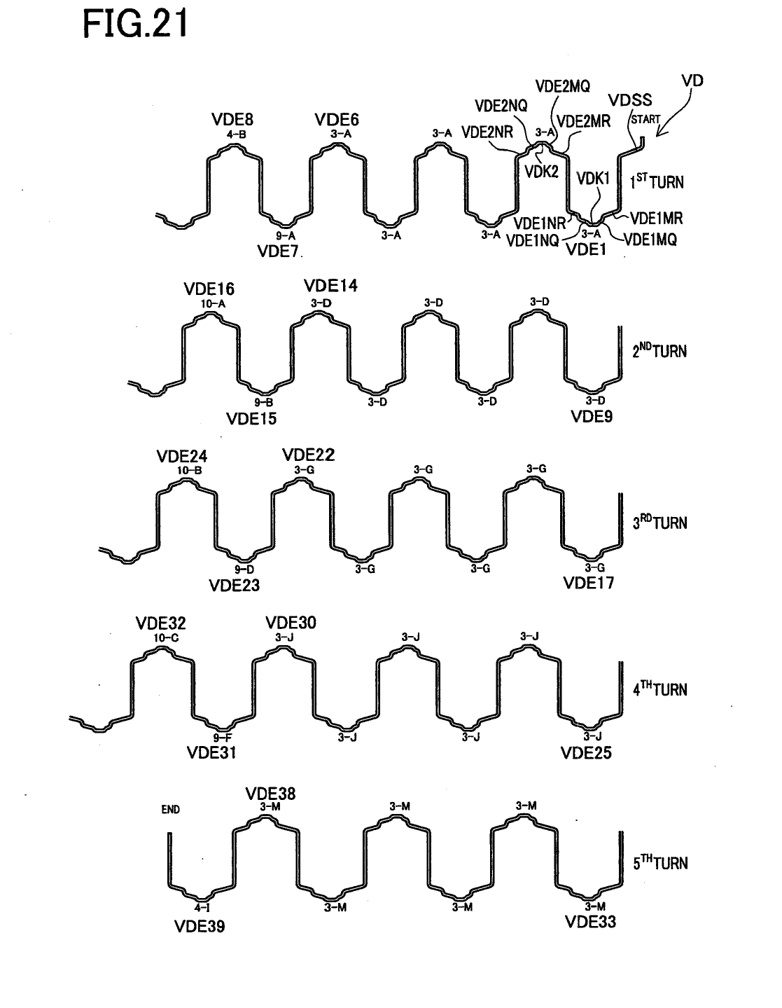

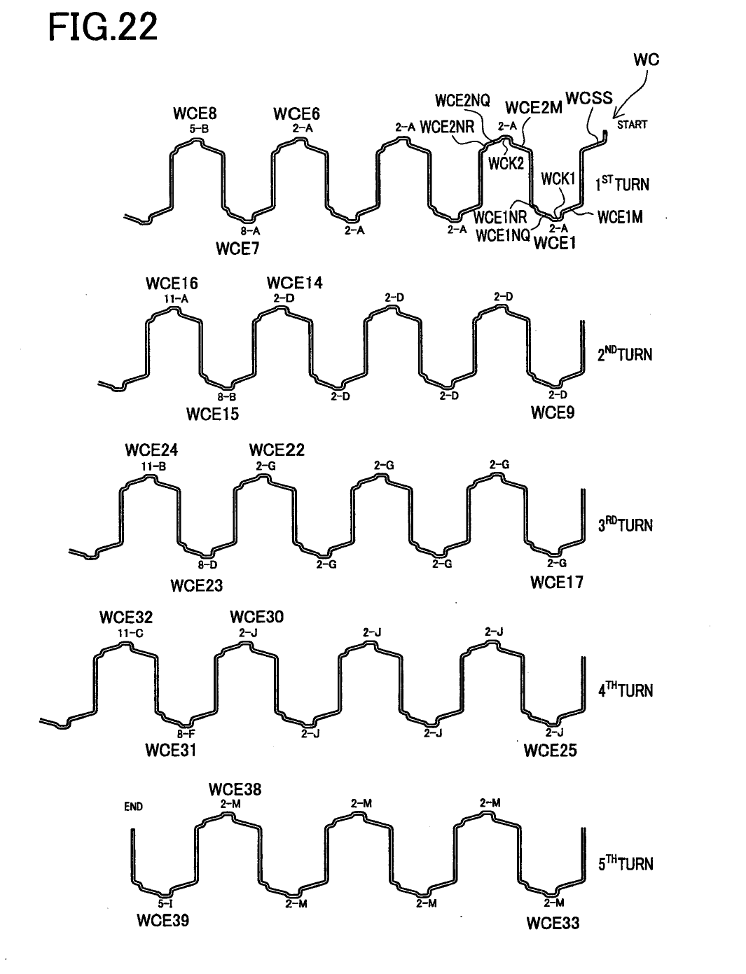

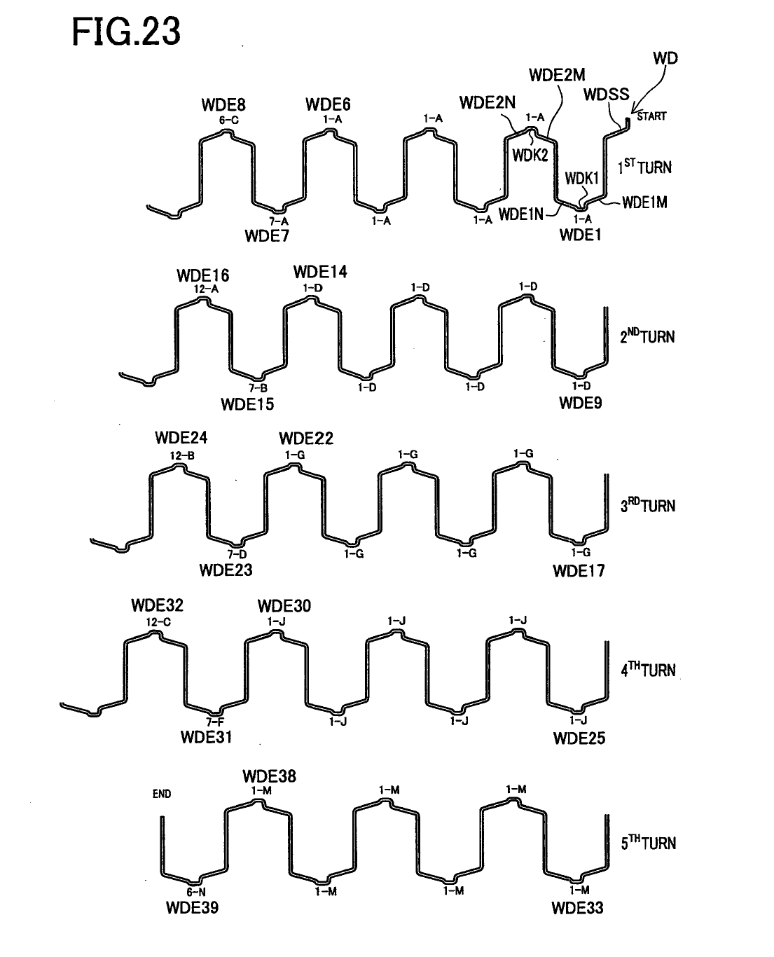

FIG. 18 shows the conductor UC (a third conductor of U phase). FIG. 19 shows the conductor UD (a fourth conductor of U phase). FIG. 20 shows the conductor VC (a third conductor of V phase). FIG. 21 shows the conductor VD (a fourth conductor of V phase). FIG. 22 shows the conductor WC (a third conductor of W phase). FIG. 23 shows the conductor WD (a fourth conductor of W phase). The conductor UC has the same shape as the conductor WB excepting the shape of a winding start portion SS and the extending direction of a protruding portion being reversed. Similarly, the conductor UD has the same shape as the conductor WA. The conductor VC has the same shape as the conductor VB. The conductor VD has the same shape as the conductor VA. The conductor WC has the same shape as the conductor UB. The conductor WD has the same shape as the conductor UA. The conductors UD, VC, VD, WC, and WD are different from the conductors WA, VB, VA, UB, and UA respectively in the shape of a winding start portion SS and the extending direction of a protruding portion being reversed.

The conductors in the second embodiment are explained in detail above. The following explanation is given to a first combined conductor X, a second combined conductor Y, and a conductor assembly Z in the second embodiment. Their configurations are substantially the same as those in the first embodiment. Accordingly, similar or identical components are given the same reference signs and their explanations are not repeated herein. Only differences from the first embodiment are explained in detail below.

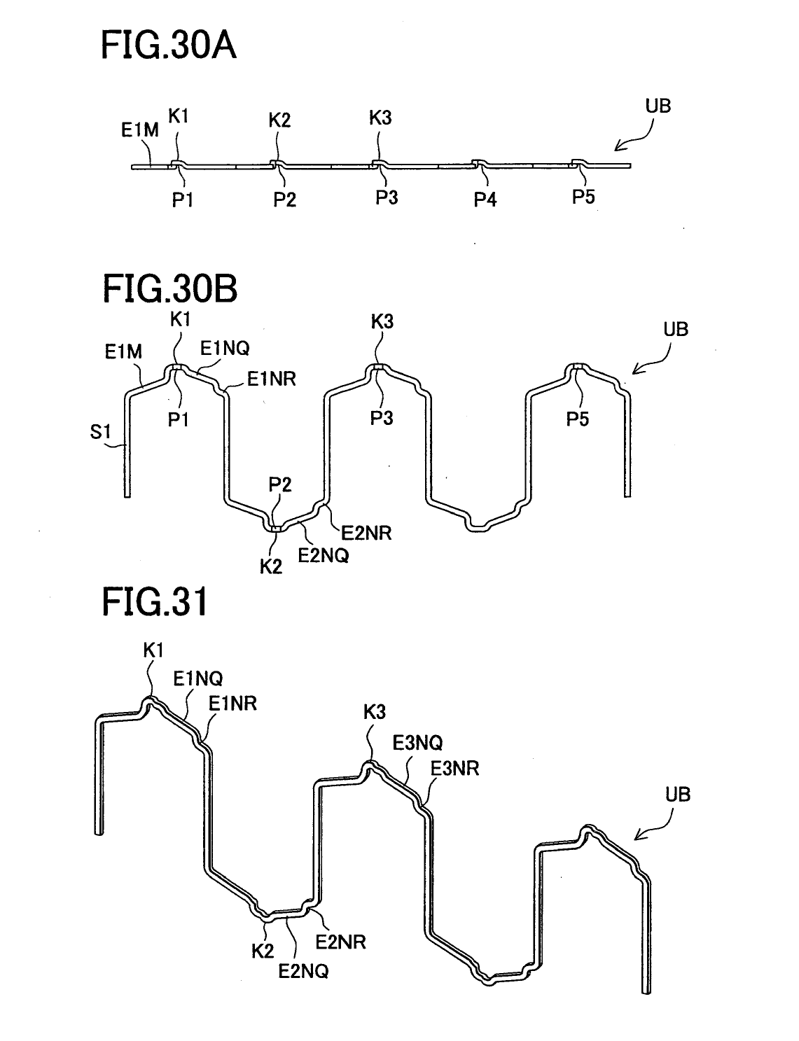

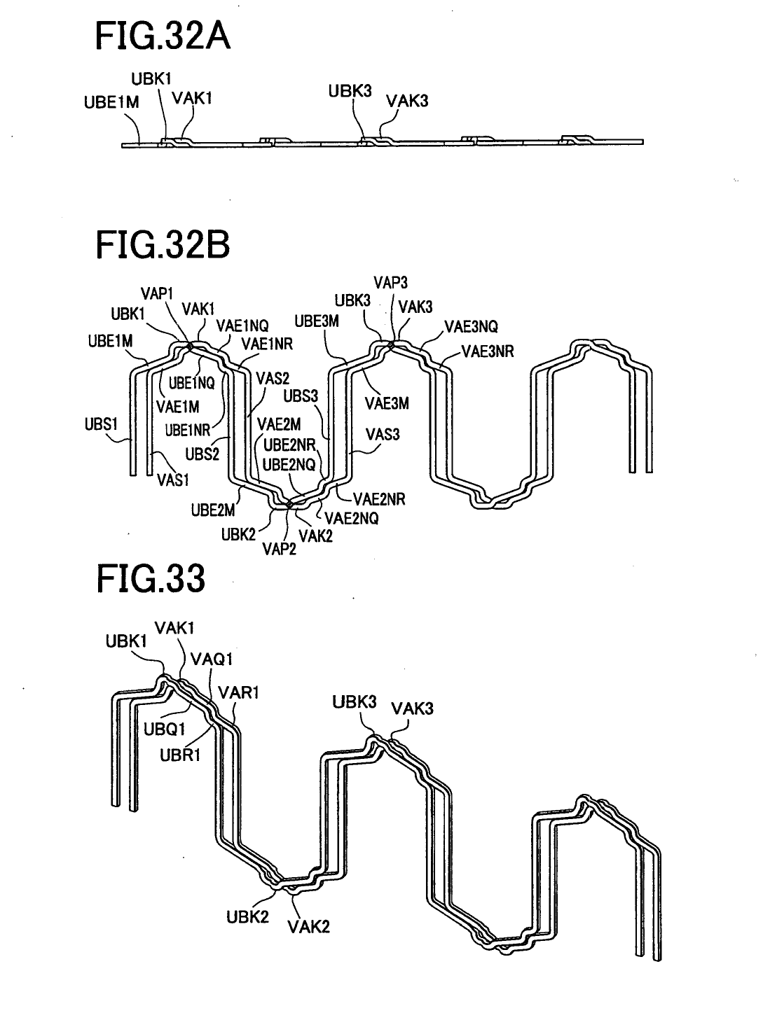

FIGS. 30A and 30B show the shape of the conductor UB (the second conductor of U phase). Specifically, FIG. 30A is a plan view of the conductor UB viewed from above and FIG. 30B is a front view thereof. FIG. 31 is a perspective view of the conductor UB. FIGS. 30A, 30B, and 31 show only part of the conductor UB in the same turn (layer), not entirely. The reference signs are serial from 1 for the sake of convenience and do not correspond to the numbers used in FIG. 13. The same applies to FIG. 32 and subsequent figures.

The conductor UB has a continuous zig-zag form including an in-slot portion S1 to be mounted in a slot, a connecting portion E1 to be circumferentially placed outside the slots, an in-slot portion S2, a connecting portion E2, . . . , an in-slot portion S5, a connecting portion E5, . . . .

Each of the connecting portions E1, E2, . . . is formed with a stepped portion K1, K2, . . . as shown in FIG. 30A. Each stepped portion K (K1, K2, . . . ) is formed in a manner that a conductor wire is bent once upward and then bent downward at a predetermined interval (length) as shown in FIG. 30A, forming a detour portion P1. In other words, the detour portion P1 is formed by twice bending. The depth of the detour portion P (P1, P2, . . . ) is equal to the thickness of the first conductor UA. The width of the detour portion P is equal to or larger than the width of the conductor UA passing through the detour portion P. The stepped portion K is followed by stair portions E1NQ and E1NR. In the position of the stair portion E1NQ, the connecting portion E has been returned to an initial position in a vertical direction in FIG. 30A. The stair portions NQ and NR are to bring the connecting portions E into close contact with connecting portions E of another conductor. Herein, a stair portion located on a near side to the stepped portion K is indicated by a sign ending in Q and a stair portion located on a far side from the stepped portion K is indicated by a sign ending in R.

The shape of the conductor UA (the first conductor of U phase) has no detour portion P and the stepped portion UAK1 of the conductor UA is directly engaged in the first detour portion UBP1 of the conductor UB. Thus, the following explanation is given to a combination of the conductors UB and VA.

FIGS. 32A and 32B show a combination of the conductors UB and VA (the first conductor of V phase). Specifically, FIG. 32A is a plan view of the combination viewed from above and FIG. 32B is a front view thereof. FIG. 33 is a perspective view of the combination:

As shown in FIGS. 32A and 33, the stepped portion UBK1 of the conductor UB is engaged in the first detour portion VAP1 (indicated by hatching lines in FIG. 32B) of the conductor VA. Thus, the front part VAE1M of the conductor VA is located under the front part UBE1M of the conductor UB with displacement therefrom in the longitudinal direction of the conductor UB as shown in FIGS. 32B and 33.

On top of the rear stair portion UBE1NQ, the rear stair portion VAE1NQ of the conductor VA is placed with displacement therefrom in the longitudinal direction. On top of the rear stair portion UBE1NR of the conductor UB, the rear stair portion VAE1NR of the conductor VA is located with displacement therefrom in the longitudinal direction. In other words, between before and behind the stepped portions UBK1 and VAK1, the connecting portions of the conductor UB are reversed in vertical position from those of the conductor VA. The conductors UB and VA constantly have the same width in the vertical direction.

In a connecting portion E2, the second stepped portion UBK2 of the conductor UB is engaged in the detour portion VAP2 (indicated by hatching lines in FIG. 32B) formed in the second stepped portion VAK2 of the conductor VA.

Accordingly, on top of the front part UBE2M of the conductor UB, the front part VAE2M of the conductor VA is placed with displacement therefrom in the longitudinal direction. Under the rear stair portion UBE2NQ of the conductor UB, the rear stair portion VAE2NQ of the conductor VA is located with displacement in the longitudinal direction. Under the rear stair portion UBE2NR of the conductor UB, the rear stair portion VAE2NR of the conductor VA is located with displacement therefrom in the longitudinal direction. In other words, between before and behind the stepped portions UBK2 and VAK2, the connecting portions of the conductor UB are reversed in vertical position from those of the conductor VA.

In a connecting portion E3, the third stepped portion UBK3 of the conductor UB is engaged in the detour portion VAP3 (indicated by hatching lines in FIG. 32B) formed in the third stepped portion VAK3 of the conductor VA. Accordingly, under the front part UBE3M of the conductor UB, the front part VAE3M of the conductor VA is placed with displacement therefrom in the longitudinal direction. The same applies to the following configurations and the details thereof are not repeated herein. At each overlapping position, the conductors UB and VA are reversed in vertical position. The first in-slot portion UBS1 of the conductor UB and the first in-slot portion VAS1 of the conductor VA are located slightly apart from each other.

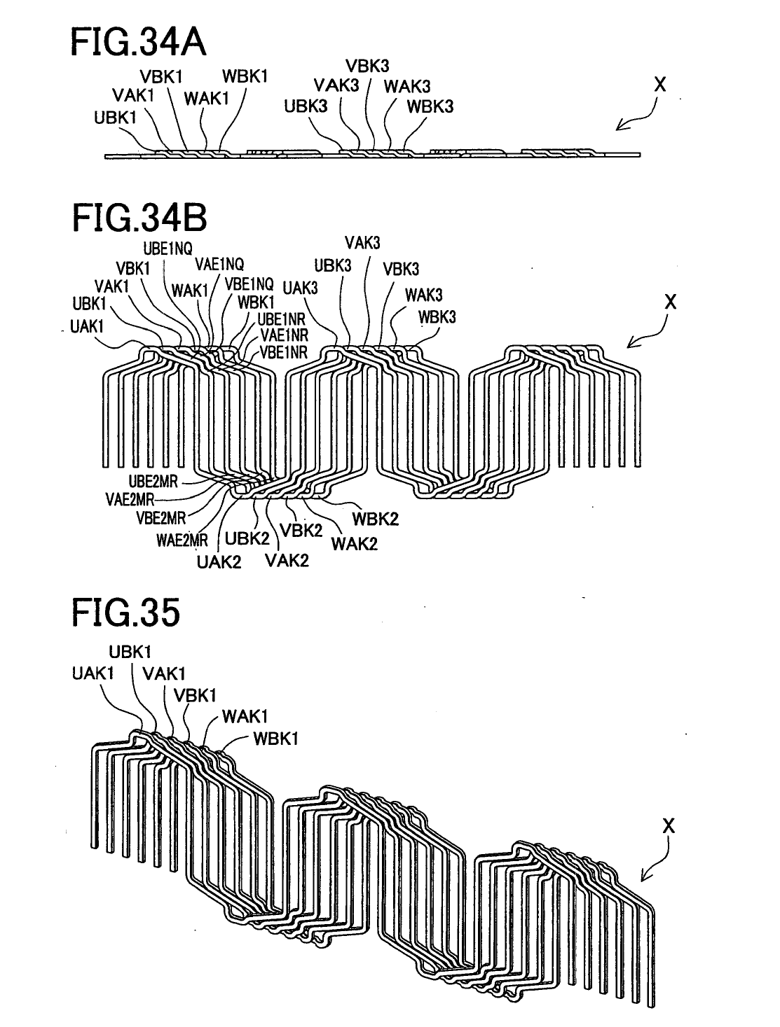

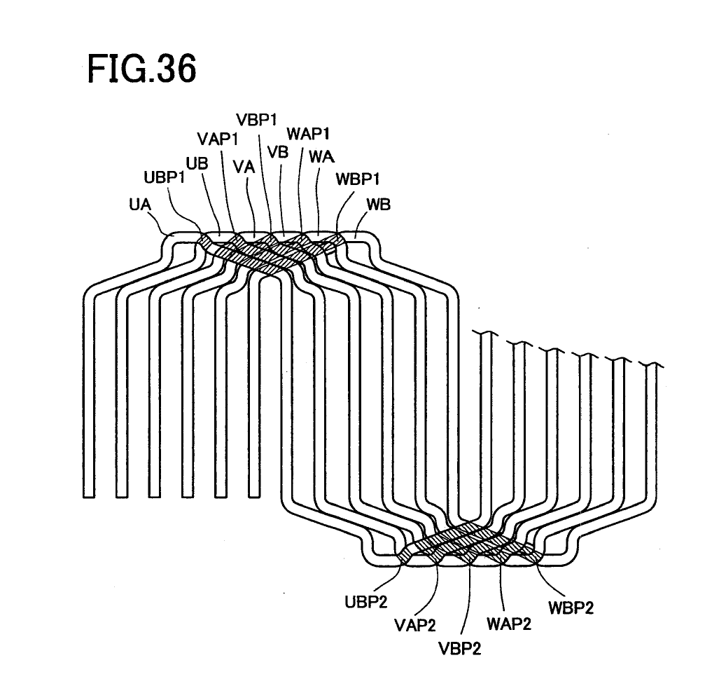

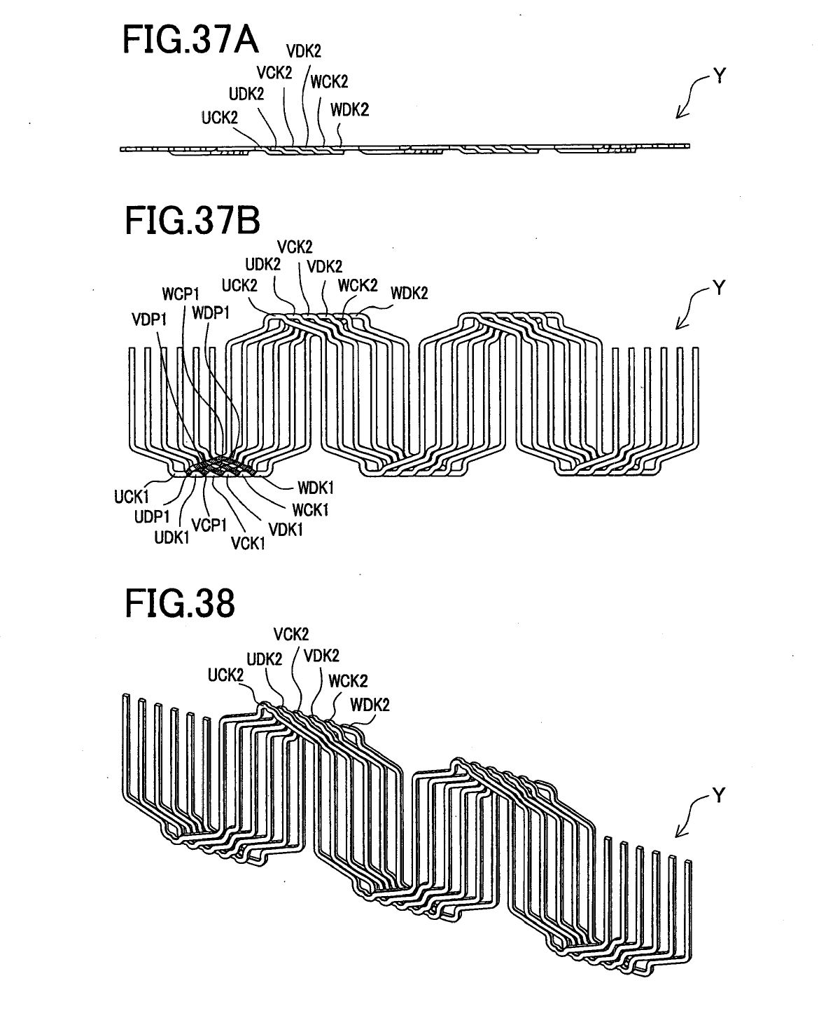

FIGS. 34A and 34B show the first combined conductor X obtained by combining six conductors, i.e., the conductor UA (a first conductor of U phase), the conductor UB (a second conductor of U phase), a conductor VA (a first conductor of V phase), a conductor VB (a second conductor of V phase), a conductor WA (a first conductor of W phase), and a conductor WB (a second conductor of W phase). FIG. 34A is a plan view of the combined conductor X viewed from above and FIG. 34B is a front view thereof. FIG. 35 is a perspective view of the first combined conductor X. FIG. 36 is an enlarged view of part of the first combined conductor X of FIG. 34B.

As shown in FIGS. 34A, 35, and 36, the detour portion UBP1 of the conductor UB has the width that receives the conductor UA passing across the conductor UB. In FIG. 36, each detour portion P is indicated by hatching lines.

The detour portion VAP1 of the conductor VA has the width that receives the conductors UA and UB passing across the conductor VA. The detour portion VBP1 of the conductor VB has the width that receives the conductors UA, UB, and VA passing across the conductor VB. The detour portion WAP1 of the conductor WA has the width that receives the conductors UA, UB, VA, and VB passing across the conductor WA. The detour portion WBP1 of the conductor WB has the width that receives the conductors UA, UB, VA, VB, and WA passing across the conductor WB. Specifically, the widths of the detour portions UBP1, VAP1, VBP1, WAP1, and WBP1 are sequentially wider.

The above explanation also applies to the detour portions UBP2, VAP2, VBP2, WAP2, and WBP2 shown in FIG. 36 and thus their details are not repeated herein. In the first combined conductor X, accordingly, each portion has the thickness corresponding to two conductor segments overlapping each other.

The conductors UA and WB are symmetric in shape to each other about the center line of each connecting portion E as shown in FIGS. 12 and 17. The conductors UB and WA are symmetric in shape to each other about the center line of each connecting portion E as shown in FIGS. 13 and 16. The conductors VA and VB are symmetric in shape to each other about the center line of each connecting portion E as shown in FIGS. 14 and 15.

In each front part EM in the upper part of the combined conductor X, accordingly, the connecting portions UAEM, UBEM, VAEM, VBEM, WAEM, and WBEM are stacked one under another in close contact relation including the stair portions Q and R. In the rear part EN, similarly, the connecting portions UAEN, UBEN, VAEN, VBEN, WAEN, WBEN are stacked one on another in close contact relation including the stair portions Q and R.

The second combined conductor Y is explained below with reference to FIGS. 37A, 37B, and 38. The basic configuration of this conductor Y is identical to the first combined conductor X and thus the following explanation is focused on differences from the first combined conductor X. In FIG. 37B, some detour portions P are indicated by hatching lines.

The conductor UC has the same shape as the conductor WB. The conductor UD has the same shape as the conductor WA. The conductor VC has the same shape as the conductor VB. The conductor VD has the same shape as the conductor VA. The conductor WC has the same shape as the conductor UB. The conductor WD has the same shape as the conductor UA. Their differences are the shape of a winding start portion SS and the extending direction of a protruding portion being reversed. Thus, the second combined conductor Y is symmetric to the first combined conductor X.

FIGS. 37A and 37B show the second combined conductor Y obtained by combining six conductors, i.e., a conductor UC (a third conductor of U phase), a conductor UD (a fourth conductor of U phase), a conductor VC (a third conductor of V phase), a conductor VD (a fourth conductor of V phase), a conductor WC (a third conductor of W phase), and a conductor WD (a fourth conductor of W phase). FIG. 37A is a plan view of the second combined conductor Y viewed from above and FIG. 37B is a front view thereof. FIG. 38 is a perspective view of the second combined conductor Y. FIGS. 37A, 37B, and 38 show only part of the second combined conductor Y, not entirely. End portions are simply illustrated different from actual shapes.

The second combined conductor Y is displaced by one pitch (corresponding to six linear conductor segments) from the first combined conductor X. Accordingly, the second combined conductor Y is in an inverted orientation with respect to the first combined conductor X.

As shown in FIGS. 37A and 38, a detour portion UDP1 (indicated by hatching lines in FIG. 37B) formed in the conductor UD has the width that receives the conductor UC passing across the conductor UD. A detour portion VCP1 formed in the conductor VC has the width that receives the conductors UC and UD passing across the conductor VC. A detour portion VDP1 formed in the conductor VD has the width that receives the conductors UC, UD, and VC passing across the conductor VD. A detour portion WCP1 formed in the conductor WC has the width that receives the conductors UC, UD, VC, and VD passing across the conductor WC. A detour portion WDP1 formed in the WD has the width that receives the conductors UC, UD, VC, VD, and WC passing across the conductor WD. In other words, the widths of the detour portions UDP1, VCP1, VDP1, WCP1, WDP1 are sequentially wider. Thus, each portion of the second combined conductor Y has the thickness corresponding to two conductor segments overlapping each other as shown in FIG. 37A.

Herein, the conductors UC and WD are symmetric in shape to each other about the center line of each connecting portion E as shown in FIGS. 18 and 23. The conductors UD and WC are symmetric in shape to each other about the center line of each connecting portion E as shown in FIGS. 19 and 22. The conductors VC and VD are symmetric in shape to each other about the center line of each connecting portion E as shown in FIGS. 20 and 21.

In the front part EM, accordingly, the connecting portions UCEM, UDEM, VCEM, VDEM, WCEM, and WDEM are stacked one under another in close contact relation. Similarly, in the rear part EN, the connecting portions UCEN, UDEN, VCEN, VDEN, WCEN, and WDEN are stacked one on another in close contact relation.

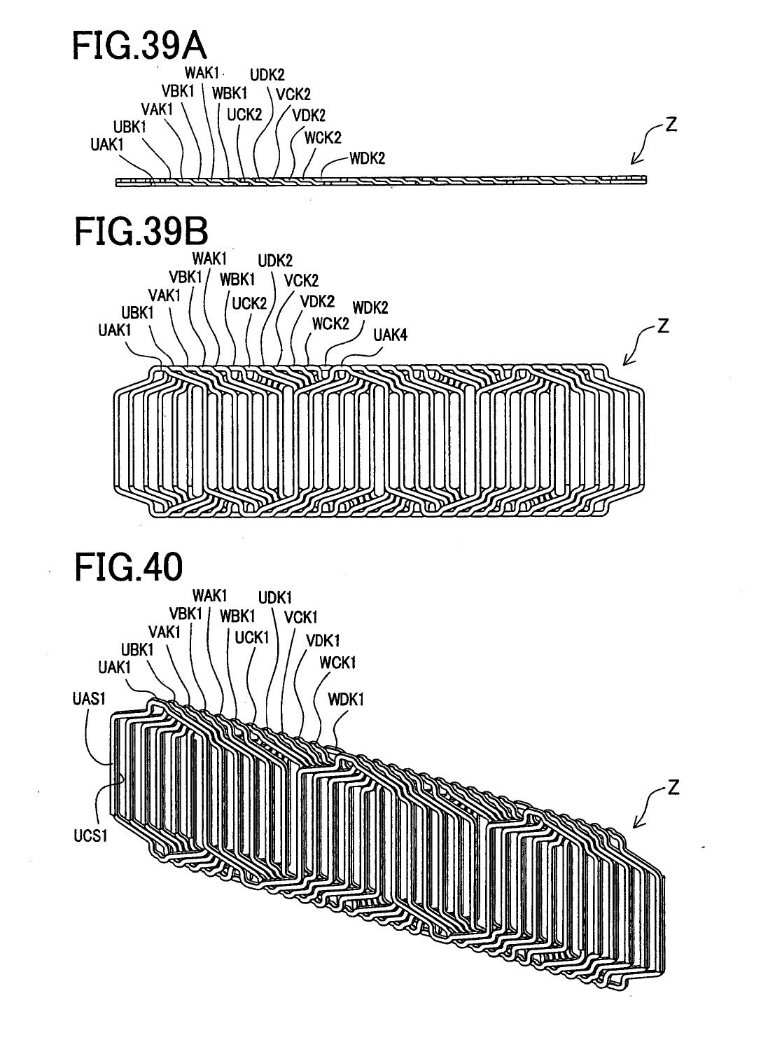

FIGS. 39A, 39B, and 40 show a conductor assembly Z obtained by combining the first and second combined conductors X and Y. Specifically, FIGS. 39A and 39B show that the first combined conductor X is simply placed overlapping the second combined conductor Y; FIG. 39A is a plan view of the conductor assembly Z viewed from above and FIG. 39B is a front view thereof. FIG. 40 is a perspective view of the conductor assembly Z. FIGS. 39A, 39B, and 40 show only part of the conductor assembly Z, not entirely.

The conductors UA and UC constitute a U-phase first rectangular coil. The conductors UB and UD constitute a U-phase second rectangular coil. The conductors VA and VC constitute a V-phase first rectangular coil. The conductors VB and VD constitute a V-phase second rectangular coil. The conductors WA and WC constitute a W-phase first rectangular coil. The conductors WB and WD constitute a W-phase second rectangular coil.

As shown in FIG. 40, the first in-slot portion S includes the first in-slot portion UAS1 of the conductor UA and the first in-slot portion UCS1 of the conductor UC that overlap each other. Similarly, each of the subsequent in-slot portions includes two overlapping in-slot portions S.

On the other hand, each connecting portion of the first combined conductor X and each connecting portion of the second combined conductor Y are located in positions not interfering with each other. Accordingly, when the first and second combined conductor X and Y are combined, each connecting portion includes two overlapping conductor segments as shown in FIG. 39A.

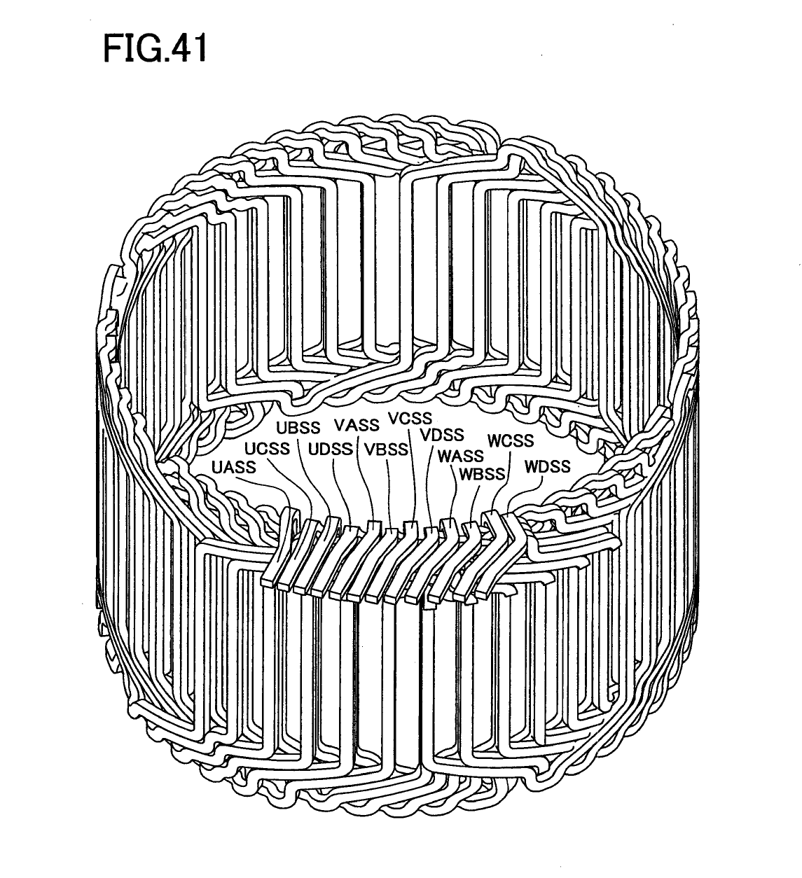

FIG. 41 shows a state where the conductor assembly Z is wound by one turn. A stator G in this embodiment has forty-eight slots and thus the conductor assembly Z includes forty-eight in-slot portions. S per one turn (layer). That is, in a slot holding the U-phase first coil constituted of the conductors UA and UC (UA+UC), for example, eight pairs of in-slot portions are mounted; i.e., UAS1+UCS1, UAS2+UCS2, UAS3+UCS3, UAS4+UCS4, UAS5+UCS5, UAS6+UCS6, UAS7+UCS7, and UAS8+UCS8. Furthermore, in a slot holding the U-phase second coil constituted of the conductors UB and UD (UB+UD), eight pairs of in-slot portions are inserted; i.e., UBS1+UDS1, UBS2+UDS2, UBS3+UDS3, UBS4+UDS4, UBS5+UDS5, UBS6+UDS6, UBS7+UDS7, and UBS8+UDS8. The V-phase and the W-phase are similar to above.

The stator G in this embodiment includes ten in-slot portions in each slot and therefore the conductor assembly Z is wound by five turns. Herein, the coil diameter of each of 2^{nd}, 3^{rd}, and subsequent layers is sequentially increased as compared with the 1^{st} layer and accordingly the length of the connecting portions is also increased sequentially. As shown in FIG. 11, the conductor assembly Z is wound by five turns to provide ten in-slot portions S in each slot.

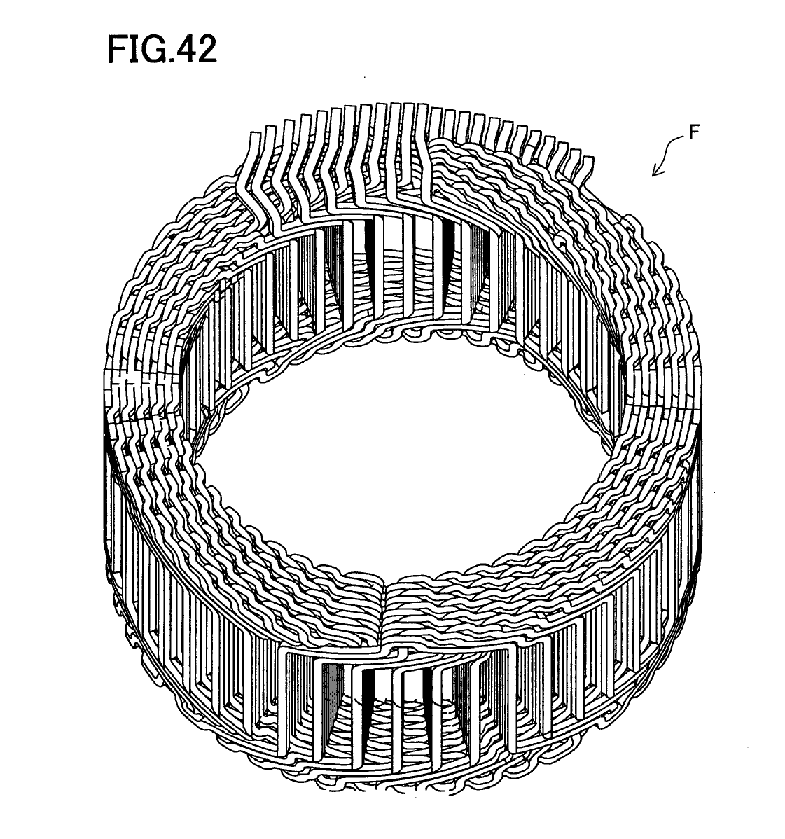

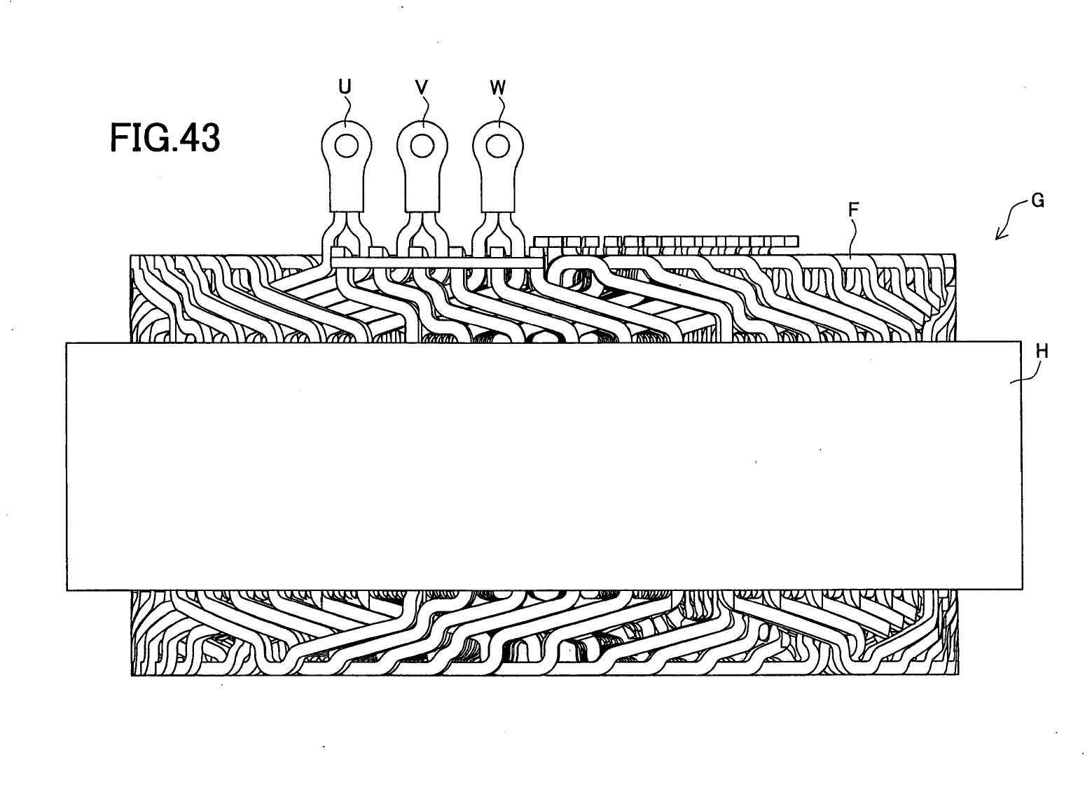

FIG. 42 is a perspective view of a cage coil F in this embodiment. From outside of this cage coil F, split core parts Hh (identical to those shown in FIG. 11) are inserted between the in-slot portions to combine a stator core H with the cage coil F. The thus completed stator G includes a U-phase terminal U, a V-phase terminal V, and a W-phase terminal W. FIG. 43 is a front view of the completed stator G.

As explained in detail above, according to the stator G and the cage coil F in the second embodiment, at each stepped portion K which are overlapping portions of the first conductors UA, UB, VA, VB, WA, and WB placed one on another sequentially with displacement from preceding ones, each conductor placed behind a preceding conductor includes a first detour portion P detouring the preceding conductor. At each stepped portion K which are overlapping portions of the second conductors UC, UD, VC, VD, WC, and WD placed one on another sequentially with displacement from preceding ones, each conductor placed behind a preceding conductor includes a second detour portion P detouring the preceding conductor. Accordingly, the first conductors UA, UB, VA, VB, WA, and WB and the second conductors UC, UD, VC, VD, WC, and WD are simply overlapped without braiding them. This makes it possible to enhance production efficiency and also achieve the circular outer periphery of the cage coil without requiring a pressing operation in a later process, thus uniformly mounting each coil in the slots.

Furthermore, the widths of the first detour portions P and the second detour portions P are sequentially wider. Six first conductors UA, UB, VA, VB, WA, and WB are sequentially overlapped and displaced by striding over the preceding ones. Six second conductors UC, UD, VC, VD, WC, and WD are sequentially overlapped and displaced by striding over the preceding ones. Thus, no braiding is required. This makes it possible to enhance production efficiency and also achieve the circular outer periphery of the cage coil without needing a pressing operation in a later process, thus uniformly mounting each coil in the slots.

At each overlapping portion of the six first conductors UA, UB, VA, VB, WA, and WB sequentially overlapped and displaced, each conductor placed behind includes the stair portions MQ, MR, NQ, and NR overlapped in close contact with the preceding conductors in the axial direction of the stator. The volume of each coil end can therefore be made compact.

The overlapping portions of the first combined conductor X and the overlapping portions of the second combined conductor Y are alternately arranged in each coil end portion E. In the conductor assembly Z, each portion includes two conductor segments overlapping each other. Any portion of the conductor assembly Z including the coil end portions E is formed from two overlapping conductor segments. This makes it possible to enhance production efficiency and also achieve the circular outer periphery of the cage coil without needing a pressing operation in a later process, thus uniformly mounting each coil in the slots. Furthermore, compact coil ends can be achieved.

The present invention is not limited to the above embodiments and may be embodied in other specific forms without departing from the essential characteristics thereof.

For instance, although the embodiments do not mention a molding process of the stator assembly, the stator assembly shown in FIG. 43 may be molded with resin to produce a completed stator.

Although the above embodiments explain the case of winding each conductor by five turns with ten conductor wires in each slot, the number of turns may be determined depending on desired torque or other conditions.

### REFERENCE SIGNS LIST

UA, UB, UC, UD U-phase conductor
VA, VB, VC, VD V-phase conductor
WA, WB, WC, WD W-phase conductor
X First combined conductor
Y Second combined conductor
Z Conductor assembly
G Stator
H Stator core
K Stepped portion
S In-slot portion
E Connecting portion
EM Front part
EMQ, EMR Stair portion
EN Rear part
ENQ, ENR Stair portion
P Detour portion

1. A stator comprising:
a cage coil including:
a conductor assembly constituted of a first combined conductor and a second combined conductor that are overlapped, the conductor assembly being wound by a plurality of turns,
the first combined conductor including a plurality of first conductors each being formed in a continuous zig-zag pattern, the first conductors being sequentially overlapped one on another with displacement; and
the second combined conductor including a plurality of second conductors each being formed in a continuous zig-zag pattern, the second conductors being sequentially overlapped one over another with displacement, and the second combined conductor being placed in an inverted orientation to the first combined conductor and with displacement from the first combined conductor by a half of a length defined from a peak of an upward bent portion to a peak of an adjacent upward bent portion of the first combined conductor.

2. The stator according to claim 1, wherein
the first conductors sequentially overlapped with displacement have overlapping portions each including a detour portion for causing a first conductor overlapped behind to detour a preceding first conductor, and
the second conductors sequentially overlapped with displacement have overlapping portions each including a detour portion for causing a second conductor overlapped behind to detour a preceding second conductor.

3. The stator according to claim 2, wherein
each detour portion of the first and second conductors is formed in a radial direction of the cage coil, and
the detour portions of the first conductors have sequentially wider widths and the detour portions of the second conductors have sequentially wider widths.

4. The stator according to claim 3, wherein
each overlapping portion of the first conductors sequentially overlapped with displacement includes a stair portion in which the first conductor placed behind overlaps in close contact with the preceding first conductor in an axial direction of the stator.

5. The stator according to claim 1, wherein
the overlapping portions of the first combined conductor and the overlapping portions of the second combined conductor are alternately arranged in coil end portions so that each portion of the conductor assembly includes two overlapping conductors.

6. A cage coil comprising:
a conductor assembly constituted of a first combined conductor and a second combined conductor that are overlapped, the conductor assembly being wound by a plurality of turns,
the first combined conductor including a plurality of first conductors each being formed in a continuous zig-zag pattern, the first conductors being sequentially overlapped one on another with displacement; and
the second combined conductor including a plurality of second conductors each being formed in a continuous zig-zag pattern, the second conductors being sequentially overlapped one over another with displacement, and the second combined conductor being placed in an inverted orientation to the first combined conductor and with displacement from the first combined conductor by a half of a length defined from a peak of an upward bent portion to a peak of an adjacent upward bent portion of the first combined conductor.

7. The cage coil according to claim 6, wherein
the first conductors sequentially overlapped with displacement have overlapping portions each including a detour portion for causing a first conductor overlapped behind to detour a preceding first conductor, and
the second conductors sequentially overlapped with displacement have overlapping portions each including a detour portion for causing a second conductor overlapped behind to detour a preceding second conductor.

8. The cage coil according to claim 6, wherein
each detour portion of the first and second conductors is formed in a radial direction of the cage coil, and
the detour portions of the first conductors have sequentially wider widths and the detour portions of the second conductors have sequentially wider widths.

9. The cage coil according to claim 8, wherein
each overlapping portion of the first conductors sequentially overlapped with displacement includes a stair portion in which the first conductor placed behind overlaps in close contact with the preceding first conductor in an axial direction of the stator.

10. The cage coil according to claim 6, wherein
the overlapping portions of the first combined conductor and the overlapping portions of the second combined conductor are alternately arranged in coil end portions so that each portion of the conductor assembly includes two overlapping conductors.
